(19) United States
(12) Patent Application Publication
(10) Pub. No.: US 2015/0120603 A1
(43) Pub. Date: Apr. 30, 2015

(54) Devices, Systems, and Methods for Streamlining Mail Delivery

(71) Applicant: The University of North Carolina at Greensboro, Greensboro, NC (US)

(72) Inventor: Robert Guy Walker, Greensboro, NC (US)

(21) Appl. No.: 14/525,727

(22) Filed: Oct. 28, 2014

Related U.S. Application Data
(60) Provisional application No. 61/896,198, filed on Oct. 28, 2013.

(51) Int. Cl. G06Q 10/08; H04L 29/08

(52) U.S. Cl. CPC G06Q 10/0836; H04L 67/10
USPC 705/339

(57) ABSTRACT

The present disclosure relates generally to devices, systems, and methods for streamlining mail delivery. A recipient identifier corresponding to a physical mail item addressed to an intended recipient is received can be received. A storage location for the physical mail item may be determined. Prior to determining the storage location for the physical mail item, the storage location may be currently associated with the intended recipient. After determining the storage location, the storage location may be associated with the intended recipient. An electronic notification can be sent to the intended recipient. The electronic notification may comprise a storage location identifier. The storage location identifier may be usable to identify the storage location of the physical mail item.

### CROSS-REFERENCE TO RELATED APPLICATIONS

This application claims priority under 35 U.S.C. §119 to U.S. Provisional Patent Application No. 61/896,198, filed Oct. 28, 2013, entitled “Methods and Systems for Streamlining Mail Delivery,” the entirety of which is hereby incorporated by reference.

### FIELD

The present disclosure relates generally to systems and methods for streamlining mail delivery.

### BACKGROUND

Traditionally, every member of an organization has had a fixed, predetermined mailbox for letter and/or package delivery. As the number of members of an organization increases the amount of space required to have fixed, predetermined mailboxes for each member of the organization likewise increases.

### SUMMARY

Embodiments provide devices, systems, and methods for streamlining mail delivery. For example, in one embodiment, a method comprises receiving, by a processor, first information. The first information may be usable to determine a unique mailbox. A method may comprise receiving, by a processor, second information usable. The second information may be usable to determine a unique recipient of an item. A method may comprise associating, by a processor, the unique mailbox with the unique recipient of the item in a data store. In some embodiments, a method comprises receiving, by a processor, third information. The third information may correspond to a unique tracking identifier for the item. A method may comprise associating, by a processor, at least one of the unique mailbox or the unique recipient, or both, with the unique tracking identifier in the data store. A method may comprise updating, by a processor, the data store to indicate that the unique mailbox is occupied. A method can comprise querying, by a processor, the data store to determine an email address corresponding to the unique recipient. A method may comprise sending, by a processor, a notification to the email address, the notification indicating that the unique recipient has at least one item available for pickup. In some embodiments, the notification comprises a pickup code usable to determine the unique mailbox. The item may comprise an address. The address can comprise a unique recipient identifier. In embodiments, the received second information comprises the unique recipient identifier.

In one embodiment, a method comprises receiving, by a processor, first information usable to determine a unique mailbox in which an item for an intended recipient is stored; querying, by a processor, a data store with the first information to determine the unique mailbox; receiving, by a processor, second information corresponding with at least one of a unique mailbox identifier and a unique tracking identifier for the item; and updating, by a processor, the data store to indicate that the unique mailbox is empty.

In an embodiment, a method comprises receiving a recipient identifier. The recipient identifier may correspond to a physical mail item addressed to an intended recipient. The physical mail item may comprise a package or a letter. The recipient identifier can comprise a unique member identifier for an organization that corresponds to the intended recipient. The physical mail item may comprise an address for the intended recipient. The address can comprise the unique member identifier. The unique member identifier may correspond to an electronic communication address of the intended recipient.

A method can comprise determining a storage location for the physical mail item. The storage location may not currently be associated with the intended recipient. In one embodiment, determining the storage location for the physical mail item comprises receiving a mailbox identifier corresponding to an empty mailbox. In another embodiment, determining the storage location for the physical mail item comprises dynamically determining an empty mailbox from a plurality of mailboxes. Each mailbox in the plurality of mailboxes may comprise a respective unique mailbox identifier. The storage location identifier can be a unique mailbox identifier corresponding to the determined empty mailbox.

A method may comprise associating the storage location and the intended recipient. In one embodiment, associating the storage location and the intended recipient comprises associating the mailbox identifier with the recipient identifier. A method can comprise sending an electronic notification to the intended recipient. The electronic notification may comprise a storage location identifier. In embodiments, the electronic notification may be an email or a text message, or both.

A method can comprise receiving, by the processor, the storage location identifier; identifying, by the processor, the storage location based at least in part on the storage location identifier; receiving, by the processor, a confirmation that the physical mail item has been retrieved from the storage location; and after receiving the confirmation, disassociating, by the processor, the storage location from the intended recipient. The confirmation can be a signature of the intended recipient.

A method may comprise receiving, by the processor, a second recipient identifier different than the recipient identifier, the second recipient identifier corresponding to a second physical mail item addressed to a second intended recipient, wherein the second physical mail item comprises a second package or a second letter; determining, by the processor, the storage location for the physical mail item based at least in part on the storage location being disassociated from the intended recipient; and associating, by the processor, the storage location with the second intended recipient.

These illustrative embodiments are mentioned not to limit or define the invention, but rather to provide examples to aid understanding thereof. Illustrative embodiments are discussed in the Detailed Description, which provides further description of the invention. Advantages offered by various embodiments of this invention may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 illustrates exemplary devices for systems and methods for streamlining mail delivery according to an embodiment;

FIG. 2 illustrates an electronic device for systems and methods for streamlining mail delivery according to an embodiment;

FIG. 3 illustrates a flow chart directed to a method for streamlining mail delivery according to an embodiment;

FIG. 4 illustrates a flow chart directed to a method for streamlining mail delivery according to an embodiment;

FIG. 5 illustrates a flow chart directed to a method for streamlining mail delivery according to an embodiment;

FIG. 6 illustrates a flow chart directed to a method for streamlining mail delivery according to an embodiment;

FIG. 7 illustrates a flow chart directed to a method for streamlining mail delivery according to an embodiment;

FIG. 8 illustrates aspects of devices, systems, and methods for streamlining mail delivery according to various embodiments;

FIG. 9 illustrates aspects of devices, systems, and methods for streamlining mail delivery according to various embodiments;

FIG. 10 illustrates aspects of devices, systems, and methods for streamlining mail delivery according to various embodiments;

FIG. 11 illustrates aspects of devices, systems, and methods for streamlining mail delivery according to various embodiments;

FIG. 12 illustrates aspects of devices, systems, and methods for streamlining mail delivery according to various embodiments;

FIG. 13 illustrates aspects of devices, systems, and methods for streamlining mail delivery according to various embodiments;

FIG. 14 illustrates aspects of devices, systems, and methods for streamlining mail delivery according to various embodiments;

FIG. 15 illustrates aspects of devices, systems, and methods for streamlining mail delivery according to various embodiments;

FIG. 16 illustrates aspects of devices, systems, and methods for streamlining mail delivery according to various embodiments;

FIG. 17 illustrates aspects of devices, systems, and methods for streamlining mail delivery according to various embodiments;

FIG. 18 illustrates aspects of devices, systems, and methods for streamlining mail delivery according to various embodiments;

FIG. 19 illustrates aspects of devices, systems, and methods for streamlining mail delivery according to various embodiments;

FIG. 20 illustrates aspects of devices, systems, and methods for streamlining mail delivery according to various embodiments;

FIG. 21 illustrates aspects of devices, systems, and methods for streamlining mail delivery according to various embodiments;

FIG. 22 illustrates aspects of devices, systems, and methods for streamlining mail delivery according to various embodiments;

FIG. 23 illustrates aspects of devices, systems, and methods for streamlining mail delivery according to various embodiments; and

FIG. 24 illustrates aspects of devices, systems, and methods for streamlining mail delivery according to various embodiments.

### DETAILED DESCRIPTION

Example embodiments are described herein in the context of systems and methods for streamlining mail delivery. Those of ordinary skill in the art will realize that the following description is illustrative only and is not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

### Illustrative Devices & Embodiment

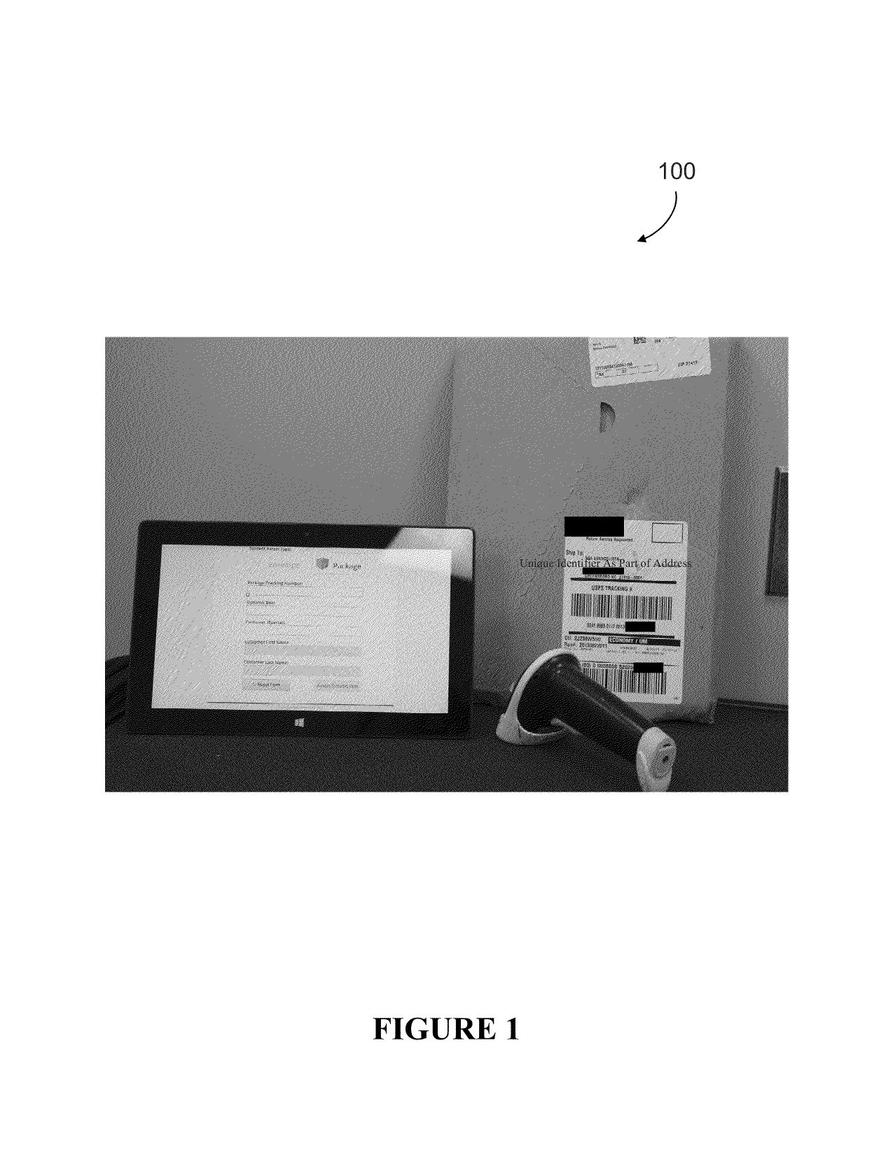

FIG. 1 illustrates exemplary devices for systems and methods for streamlining mail delivery according to an embodiment. For example, a barcode scanner, tablet, laptop, desktop computer, and/or smartphone may be used to implement aspects of the methods described herein.

In embodiments, a package addressed to a recipient and having an identifier is received by an organization. For example, a package addressed to student John Doe and having a tracking number “9Z4196901128813” may be received by an employee in the mail department of a university that John Doe is attending. In embodiments, an identifier corresponding to the intended recipient of the package is included in the address of the package. For example, the package shown in FIG. 1 may be addressed to “jdoe1234” which corresponds to his username at the university.

In embodiments, members of the organization do not have a predefined mailbox. Instead, in embodiments, when a package is sent to a member of the organization, a temporary mailbox is dynamically determined. For example, when the package for John Doe is received by the mail department at the university, an employee may determine an empty mailbox for the package from a plurality of mailboxes. The plurality of mailboxes may not be assigned to particular members of the organization and, thus, may save space by dynamically allocating resources as they are needed instead of providing each member with predetermined mailboxes.

In embodiments, the dynamically determined mailbox is temporarily associated with the package and/or the intended recipient. For example, in an embodiment, the employee can scan a barcode of the tracking number on the package, then scan a barcode corresponding to the determined mailbox, and then enter the identifier corresponding to the recipient specified in the address of the package. As another example, in an embodiment, the employee can type in the tracking number corresponding to the package, then type in a mailbox number in which the package will be placed, and then type in a username of the recipient. The package, determined mailbox, and/or the intended recipient can be associated with each other. For example, when the employee scans and/or enters the information described above, one or more databases can be updated to indicate that the package having tracking number “9Z4196901128813” and intended for “jdoe1234” is in mailbox “B9826.” Numerous other embodiments are disclosed herein and variations are within the scope of this disclosure.

In embodiments, the intended recipient's username is an email address or is an identifier that can be used to determine an email address corresponding to the intended recipient. In this embodiment, an email notification can be sent to the intended recipient. For example, an email may be sent to an email address corresponding to “jdoe1234” stating that he has a package that needs to be picked up. In embodiments, the email has a pickup identifier, the name of the intended recipient, the tracking number, the mailbox number where the package is located, and/or other information. Numerous other embodiments are disclosed herein and variations are within the scope of this disclosure.

When the intended recipient, John Doe, wishes to pick up the package, he can go to the mail department at the university and provide an employee with his name, pickup code, and/or username. The employee can then look up the mailbox numbers for the mailboxes that have packages for John Doe. In embodiments, the employee can scan and/or enter the mailbox numbers that have packages for John Doe to indicate that that packages in those mailboxes have been picked up. In some embodiments, the employee can scan and/or enter the tracking numbers of the packages in the mailboxes corresponding to the determined mailbox numbers to indicate that the packages have been picked up. Numerous other embodiments are disclosed herein and variations are within the scope of this disclosure.

In embodiments, a signature from the person picking up one or more packages is obtained. For example, when John Does receives his package(s) he may sign a box displayed on a tablet computer indicating that he picked up the package(s). In embodiments, once package(s) have been picked up, one or more mailbox(es) that had previously been marked as occupied may be marked as empty. For example, when John Does picks up his packages, then any mailboxes that held those packages can be marked as empty once the packages have been picked up.

This illustrative example is given to introduce the reader to the general subject matter discussed herein. The invention is not limited to this example. The following sections describe various additional non-limiting embodiments and examples of devices, systems, and methods for streamlining mail delivery.

### Illustrative Device

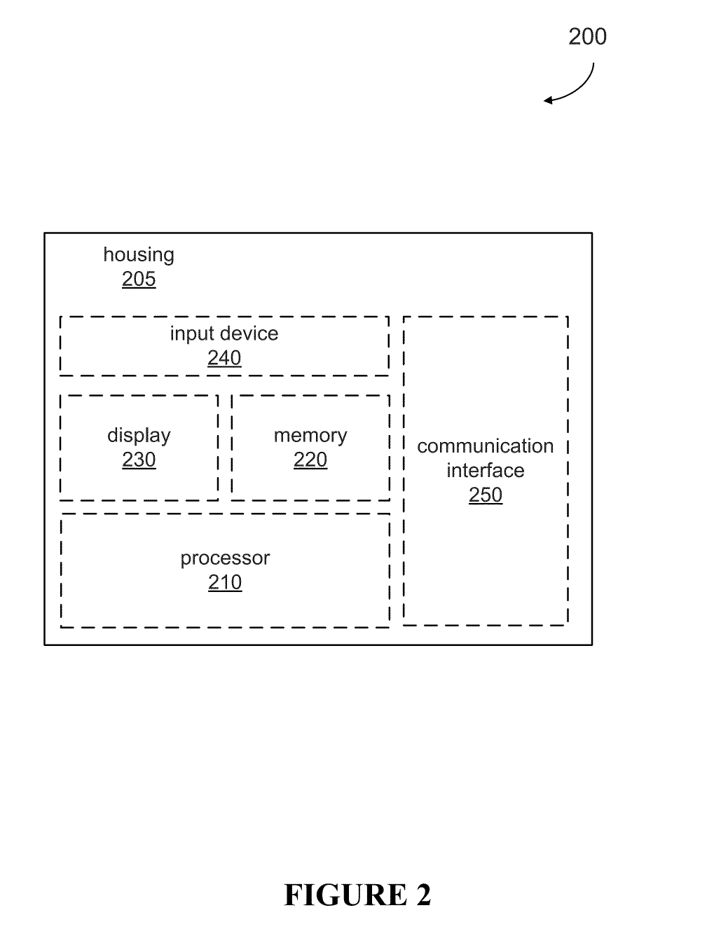

FIG. 2 illustrates an electronic device 200 for streamlining mail delivery. In the embodiment shown in FIG. 2, the electronic device 200 comprises a housing 205, a processor 210, a memory 220, a display 230, an input device 240, and a communication interface 250. The processor 210 is in communication with the memory 220 and, in this embodiment, both the processor 210 and the memory 220 are disposed within the housing 205. The display 230 can be a touch-sensitive display which comprises or is in communication with a touch-sensitive surface that is partially disposed within the housing 205 such that at least a portion of the display 230 is exposed to a user of the electronic device 200. In some embodiments, the display 230 may not be disposed within the housing 205. For example, the electronic device 200 may be connected to or otherwise communicate with a display 230 disposed within a separate housing.

In the embodiment shown in FIG. 2, the display 230 is in communication with the processor 210 and is configured to provide signals to the processor 210 and/or the memory 220 and to receive signals from the processor 210 and/or memory 220. The memory 220 is configured to store program code or data, or both, for use by the processor 210, which is configured to execute program code stored in memory 220 and to transmit signals to and receive signals from the display 230. In the embodiment shown in FIG. 2, the processor 210 is in communication with the communication interface 250 and is configured to receive signals from the communication interface 250 and to output signals to the communication interface 250 to communicate with other components or devices such as one or more electronic devices. In addition, the processor 210 is in communication with input device 240. Input device 240 can be any number of devices including, but not limited to, a keyboard, a keypad, a mouse, a joystick, a trackball, a camera, a scanner (such as a barcode scanner or another scanner), etc.

In embodiments, processor 210 receives one or more sensor signals from one or more input devices, such as input device 240, integrated into the electronic device 200, connected to the electronic device 200, and/or in communication with the electronic device 200. For example, the processor 210 may receive one or more sensor signals from a touch-sensitive surface of the display 230. As another example, the processor 210 may receive one or more sensor signals from an input device such as a keyboard, a mouse, a touchpad, a trackball, a microphone, a touch-sensitive surface, and/or another suitable input device that is integrated into the electronic device 200, connected to the electronic device 200, and/or in communication with the electronic device 200. Numerous other embodiments are disclosed herein and variations are within the scope of this disclosure.

The processor 210 may then utilize the information it receives from one or more input devices (such as input device 240), one or more communication interfaces (such as communication interface 250), memory (such as memory 220), and/or another suitable input device. Numerous other embodiments are disclosed herein and variations are within the scope of this disclosure.

The device illustrated in FIG. 2 is merely illustrative, and in various other embodiments, the electronic device 200 may comprise or be in communication with fewer or additional components and/or devices than shown in FIG. 2. For example, other user input devices such as a mouse, a keyboard, a camera and/or other input device(s) may be comprised within the electronic device 200 or be in communication with the electronic device 200. As another example, electronic device 200 may not comprise a communication interface 250 in one embodiment. As yet another example, electronic device 200 may not comprise a display 230 in an embodiment. Numerous other embodiments are disclosed herein and variations are within the scope of this disclosure.

Various other components may also be modified. Thus, in various embodiments, the electronic device 200 may comprise or be in communication with any number of components, such as in the various embodiments disclosed herein as well as variations that would be apparent to one of skill in the art.

The electronic device 200 can be any device that is capable of receiving user input. For example, the electronic device 200 in FIG. 2 includes a display 230 that can comprise a touch-sensitive surface. In some embodiments, a touch-sensitive surface may be overlaid on the display 230. In other embodiments, the electronic device 200 may comprise or be in communication with a display and a separate touch-sensitive surface. In still other embodiments, the electronic device 200 may comprise or be in communication with a display and may comprise or be in communication with other user input devices, such as a mouse, a keyboard, buttons, knobs, slider controls, switches, wheels, rollers, etc.

The housing 205 of the electronic device 200 shown in FIG. 2 provides protection for at least some of the components electronic device 200. For example, the housing 205 may be a plastic casing that protects the processor 210 and memory 220 from foreign articles such as rain. In some embodiments, the housing 205 protects the components in the housing 205 from damage if the electronic device 200 is dropped by a user. The housing 205 can be made of any suitable material including but not limited to plastics, rubbers, or metals. Various embodiments may comprise different types of housings or a plurality of housings. For example, in some embodiments, electronic device 200 may be a portable device, handheld device, barcode scanner, desktop computer, portable multifunction device such as a cell phone, smartphone, personal digital assistant (PDA), laptop, tablet computer, etc. Numerous other embodiments are disclosed herein and variations are within the scope of this disclosure.

In FIG. 2, the communication interface 250 is in communication with the processor 210 and provides wired or wireless communications, from the electronic device 200 to other components or other devices. For example, the communication interface 250 may provide wireless communications between the electronic device 200 and a wireless sensor or a wireless actuation device. In some embodiments, the communication interface 250 may provide communications to one or more other devices, such as another electronic device 200, to allow users to interact with each other at their respective devices. The communication interface 250 can be any component or collection of components that enables the multi-pressure touch-sensitive input electronic device 200 to communicate with another component or device. For example, the communication interface 250 may comprise a PCI network adapter, a USB network adapter, or an Ethernet adapter. The communication interface 250 may communicate using wireless Ethernet, including 802.11 a, g, b, or n standards. In one embodiment, the communication interface 250 can communicate using Radio Frequency (RF), Bluetooth, CDMA, TDMA, FDMA, GSM, WiFi, satellite, or other cellular or wireless technology. In other embodiments, the communication interface 250 may communicate through a wired connection and may be in communication with one or more networks, such as Ethernet, token ring, USB, FireWire 1394, fiber optic, etc. In some embodiments, electronic device 200 comprises a single communication interface 250. In other embodiments, electronic device 200 comprises two, three, four, or more communication interfaces. Thus, in embodiments, electronic device 200 can communicate with one or more components and/or devices through one or more communication interfaces. In other embodiments, an electronic device 200 may not comprise a communication interface 250.

### Illustrative System

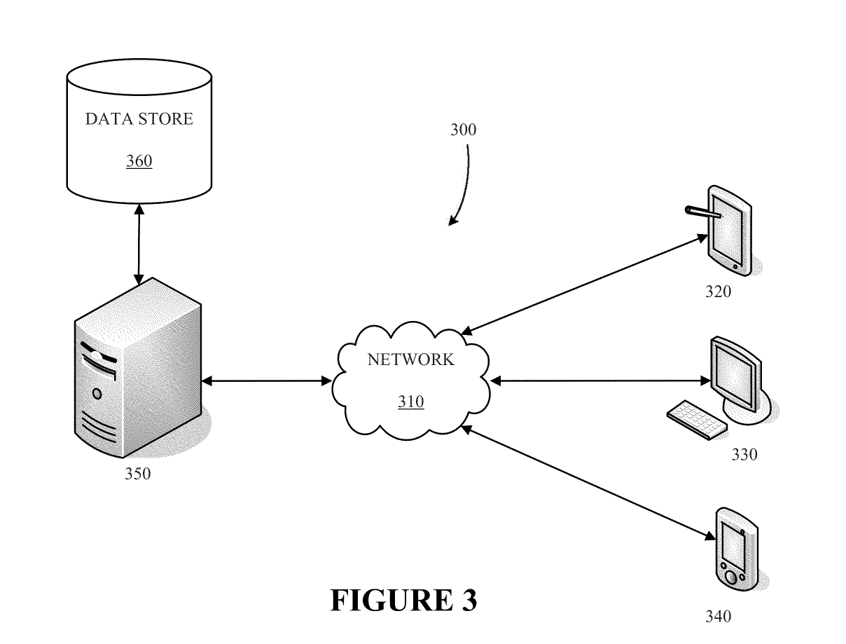

FIG. 3 illustrates a system diagram depicting illustrative computing devices for streamlining mail delivery according to an embodiment. The system 300 shown in FIG. 3 includes three electronic devices, 320-340, and a web server 350. Each of the electronic devices, 320-340, and the web server 350 are connected to a network 310. In this embodiment, each of the electronic devices, 320-340, is in communication with the web server 350 through the network 310. Thus, each of the electronic devices, 320-340, can send requests to the web server 350 and receive responses from the web server 350 through the network 310.

In an embodiment, the network 310 shown in FIG. 3 facilitates communications between the electronic devices, 320-340, and the web server 350. The network 310 may be any suitable number or type of networks or links, including, but not limited to, a dial-in network, a local area network (LAN), wide area network (WAN), public switched telephone network (PSTN), a cellular network, a WiFi network, the Internet, an intranet or any combination of hard-wired and/or wireless communication links. In one embodiment, the network 310 is a single network. In other embodiments, the network 310 may comprise two or more networks. For example, the electronic devices 320-340 may be connected to a first network and the web server 350 may be connected to a second network and the first and the second network may be connected by a third network. Numerous other network configurations would be obvious to a person of ordinary skill in the art.

An electronic device may be capable of communicating with a network, such as network 310, and capable of sending and receiving information to and from another device, such as web server 350. For example, in FIG. 3, one electronic device 320 is a tablet computer. The tablet computer 320 includes a touch-sensitive display and is able to communicate with the network 310 by using a wireless communication interface card. Another device that may be an electronic device 330 shown in FIG. 3 is a desktop computer. The desktop computer 330 is in communication with a display and is able to connect to the network 330 through a wired network connection. The desktop computer 330 may be in communication with any number of input devices such as a keyboard or a mouse. In FIG. 3, a smartphone is an electronic device 340. The smartphone 340 may be able to communicate with the network 310 over a wireless communications means using Bluetooth, CDMA, TDMA, FDMA, GSM, WiFi, or other cellular or wireless technology.

A device receiving a request from another device may be any device capable of communicating with a network, such as network 310, and capable of sending and receiving information to and from another device. For example, in the embodiment shown in FIG. 3, the web server 350 may receive a request from another device (e.g., one or more of electronic devices 320-340) and may be in communication with network 310. A receiving device may be in communication with one or more additional devices, such as additional servers. For example, web server 350 in FIG. 3 may be in communication with another server. In an embodiment, a web server may communicate with one or more additional devices to process a request received from an electronic device. For example, web server 350 in FIG. 3 may be in communication with a plurality of additional servers, at least one of which may be used to process at least a portion of a request from any of the electronic devices 320-340. In one embodiment, web server 350 may be part of or in communication with a content distribution network (CDN).

One or more devices may be in communication with a data store. In FIG. 3, web server 350 is in communication with data store 360. In embodiments, data store 360 is operable to receive instructions from web server 350 and/or other devices in communication with data store 360 and obtain, update, or otherwise process data in response to receiving the instructions. In one embodiment, an electronic device, such as tablet computer 320, comprises and/or is in communication with a data store. A data store, such as data store 360, may contain electronic content, such as names, addresses, email addresses, tracking numbers, dates, times, signatures, authorization information, delivery confirmation, package information, letter information, mailbox information, mailbox location, mailbox status (e.g., in use, not in use, etc.), unique identifiers corresponding to packages, unique identifiers corresponding to a person or organization (e.g., corresponding to a name, address, email address, etc.), unique identifiers corresponding to mailboxes, other information, or a combination thereof. Numerous other embodiments are disclosed herein and variations are within the scope of this disclosure.

Data store 360 shown in FIG. 3 can receive requests from web server 350 and send responses to web server 350. For example, in response to receiving a request from the tablet computer 320, web server 350 may query data store 360 for information stored in data store 360. Thus, if the request is for the delivery status of a package corresponding to a tracking number, then web server 350 may query data store 360 to determine the delivery status. Numerous other embodiments are disclosed herein and variations are within the scope of this disclosure.

### Illustrative Method for Streamlining Mail Delivery

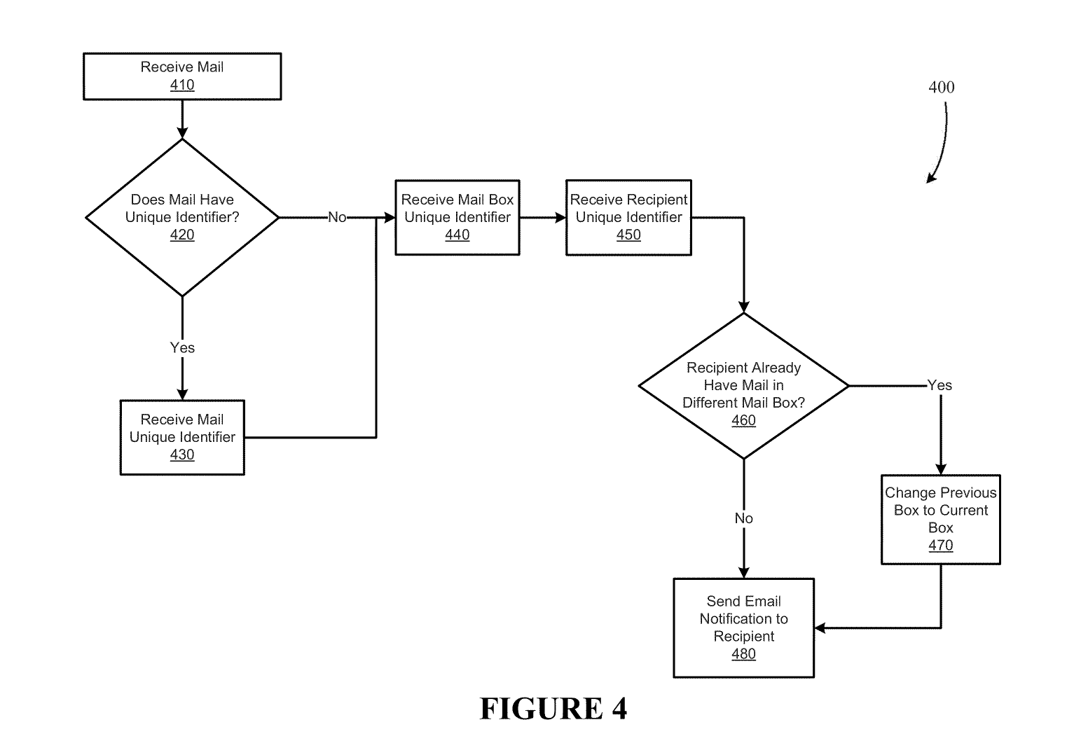

FIG. 4 illustrates a flow chart directed to a method 400 streamlining mail delivery in accordance with an embodiment. The method 400 shown in FIG. 4 may be performed, in part or in whole, by electronic device 200 shown in FIG. 2. In embodiments, method 400 can be performed by one or more of the devices shown in system 300 in FIG. 3.

The method 400 begins in block 410 when mail is received. For example, an organization may receive one or more packages and/or letters addressed to one or more intended recipients. In some embodiments, a particular piece of mail has an address of an intended recipient and/or has a recipient unique identifier corresponding to the intended recipient. For example, a particular piece of mail intended for a student of a university may have a student identification number as part of the address. In embodiments, a particular piece of mail may not have a recipient unique identifier but may have a name of the intended recipient that can be used to identify the intended recipient. In embodiments, a particular piece of mail may have an identifier corresponding to a tracking number for the piece of mail. For example, a particular piece of mail may have a UPS tracking number, a FedEx tracking number, etc. Numerous other embodiments are disclosed herein and variations are within the scope of this disclosure.

In block 420 of method 400, a determination is made as to whether a particular piece of mail has a unique tracking identifier (e.g., UPS tracking number, FedEx tracking number, etc.). If the piece of mail has a unique tracking identifier, the unique tracking number may be scanned (e.g. by a barcode scanner, camera, etc.) or otherwise entered into a device (e.g., tablet computer, desktop computer, smartphone, etc.) connected with a mail delivery system as shown in block 430. For example, a user may use a tablet computer or another suitable device to fill out a form for receiving mail displayed on a display of the tablet computer. In various embodiment, the form may be displayed within a web browser, by a plug-in, in a standalone application, etc. Numerous other embodiments are disclosed herein and variations are within the scope of this disclosure.

In block 440, a unique identifier corresponding to a mailbox is received. For example, a particular piece of mail can be taken to an available mailbox and a unique identifier corresponding to the available mailbox may be scanned or otherwise entered. Thus, for example, if a facility has 100 mailboxes and 20 of the mailboxes are empty, then in one embodiment any one of 20 the empty mailboxes can be selected. Numerous other embodiments are disclosed herein and variations are within the scope of this disclosure.

In block 450, a unique identifier corresponding to an intended recipient of the piece of mail is entered. For example, if a particular piece of mail has an address of an intended recipient that has a unique identifier corresponding to the intended recipient, then this unique identifier can be entered. As another example, a name of the intended recipient can be entered to determine a unique identifier corresponding to the intended recipient. Numerous other embodiments are disclosed herein and variations are within the scope of this disclosure.

In block 460, a determination is made as to whether the intended recipient already has mail in a different mailbox. If a determination is made that the intended recipient has mail in a different mailbox, then one or more databases can be updated such the previous mail and/or the intended recipient corresponds with the new mailbox rather than the previous mailbox as shown in block 470. Numerous other embodiments are disclosed herein and variations are within the scope of this disclosure.

In embodiments, one or more associations in one or more data stores are created and/or updated based at least in part on the received information. In embodiments, a database is updated to associate a tracking number of the package with the mailbox that the package has been placed into and/or the intended recipient. For example, a unique tracking identifier for the package may be associated with the unique mailbox identifier, and/or a unique recipient identifier. In some embodiments a database is updated to associate the intended recipient with the mailbox where the mail is being stored. For example, a unique identifier corresponding to the intended recipient may be associated with a unique identifier corresponding to the mailbox containing the mail for the intended recipient. In various embodiments, the database is updated to reflect that the mailbox is now being occupied. Numerous other embodiments are disclosed herein and variations are within the scope of this disclosure.

In block 480, an email notification is sent to the intended recipient. For example, a database may contain information regarding the intended recipient including an email address for the intended recipient. In this embodiment, the email address of the intended recipient can be determined by querying the database and an email can be sent to the intended recipient providing a notification that he or she has mail that needs to be picked up. In some embodiments, the email comprises a pickup code that can be used to determine the location of the mail that needs to be picked up. Numerous other embodiments are disclosed herein and variations are within the scope of this disclosure.

### Illustrative Method for Streamlining Mail Delivery

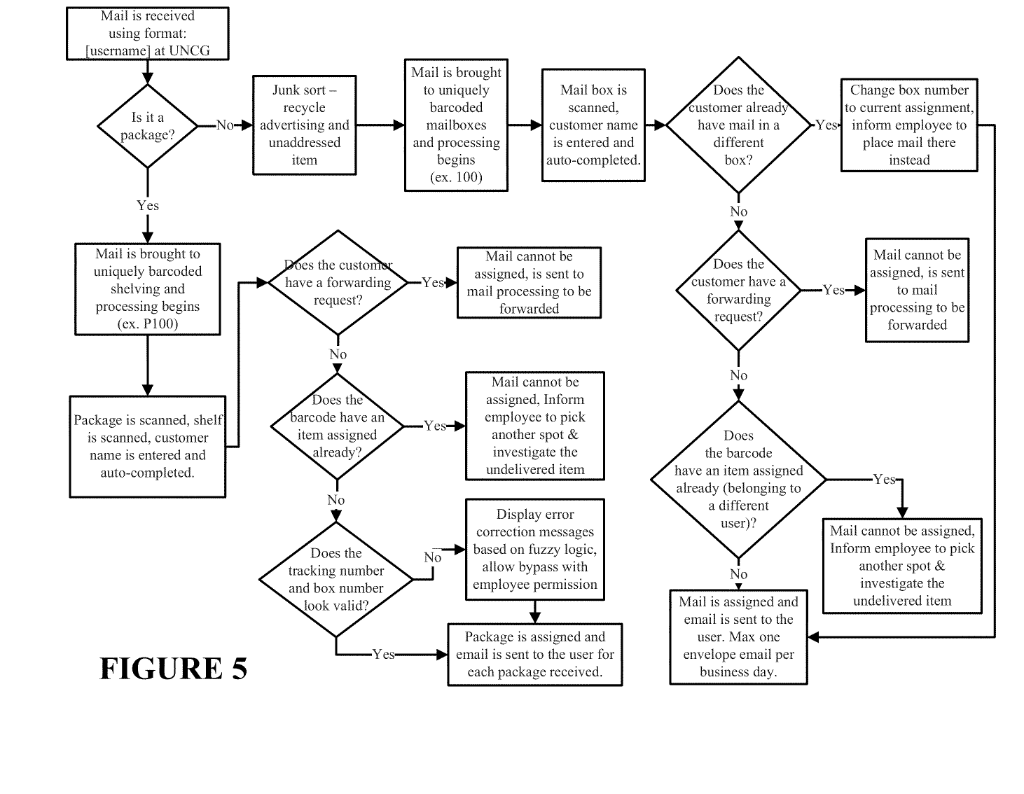

FIG. 5 illustrates aspects of systems and methods for streamlining mail delivery according to an embodiment. The described in the flow chart shown in FIG. 5 may be performed, in part or in whole, by electronic device 200 shown in FIG. 2. In embodiments, steps described in the flow chart shown in FIG. 5 can be performed by one or more of the devices shown in system 300 in FIG. 3. As shown in FIG. 5, mail is received using a specified format for an intended recipient. For example, a particular piece of mail can be received in a [username] at organization format where the username corresponds with a particular student, employee, etc. of organization. In the embodiment shown in FIG. 5, a determination is made as to whether the piece of mail is a package. In FIG. 5, if the particular piece of mail is not a package and the mail is not junk mail, then the mail is brought to a uniquely barcoded mailbox that is currently empty.

In embodiments, the mailbox does not directly correspond to the intended recipient. In other words, in some embodiments, the intended recipient does not have a predetermined, predefined mailbox for his or her mail. Instead, in this embodiment, mailboxes are dynamically determined based on their availability. Thus, in one embodiment, any available mailbox may be assigned to a piece of mail and/or a particular recipient as mail arrives. Once the mail is picked up, the mailbox can then become available for another piece of mail and/or another recipient according to various embodiments.

As shown in FIG. 5, if the mail is not a package, it is brought to an available mailbox and a unique identifier corresponding to the mailbox is entered. For example, a barcode corresponding to the mailbox may be scanned. In embodiments, the intended recipient is entered. If a determination is made that the intended recipient already has mail in a different mailbox, then a notification can be displayed to move that mail into the newly-selected mailbox. In addition, associations in one or more data stores can created and/or updated to indicate that the mail has been moved to the new mailbox. In some embodiments, a notification may be displayed to place the new mail in the previous mailbox. In this embodiment, associations in one or more data stores can update created and/or updated to indicate the new mail is being held in the mailbox that already has mail for the intended recipient.

In some embodiments, a determination is made as to whether the intended recipient has an active forwarding request. If the intended recipient has an active forwarding request, then the mail may be forwarded to an address associated with the forwarding request.

In various embodiments, systems and methods for streamlining mail delivery provide accuracy checks to verify and/or maintain the integrity of the system. For example, in FIG. 5, if a mailbox that is scanned already has an item assigned to a different intended recipient, then a notification may be provided to the employee that the system indicates that the mailbox should already be occupied or otherwise unavailable. In this embodiment, the employee may determine that the previous package has already been delivered and update the system so that the mailbox is listed as being available.

In FIG. 5, if a particular piece of mail is not a package and once a barcode corresponding to a uniquely available mailbox that is available has been scanned and information regarding the intended recipient has been entered, then the system assigns the mail to that mailbox and associates the mailbox with the intended recipient. In one embodiment, a database has an email address corresponding to the intended recipient. In embodiment's, an email is sent to the intended recipient for each piece of mail for that recipient. In other embodiments, an email notification is provided a particular number of times within a given time period (e.g., a maximum of one email per day). In embodiments, an email can be sent to an intended recipient at a specified time providing information for one or more pieces of mail that need to be picked up. Numerous other embodiments are disclosed herein and variations are within the scope of this disclosure.

Referring still to FIG. 5, if the particular piece of mail is a package, then the mail can be brought to a uniquely barcoded storage space. In this embodiment, the barcode corresponding to the storage space where the package will be stored can be scanned or otherwise entered. In addition, the intended recipient can be selected by entering the intended recipient's name and/or an identifier on the address of the package corresponding to the intended recipient. In FIG. 5, if the intended recipient does not have a forwarding request and the system does not indicate that the storage space has is currently occupied, then one or more databases may updated to associate the package with the storage space. For example, the unique barcode for the storage space may be associated with the intended recipient and/or tracking information associated with the package. In embodiments, an email is sent to the intended recipient indicating that the package has been received and is ready for pickup. Numerous other embodiments are disclosed herein and variations are within the scope of this disclosure.

### Illustrative Method for Streamlining Mail Delivery

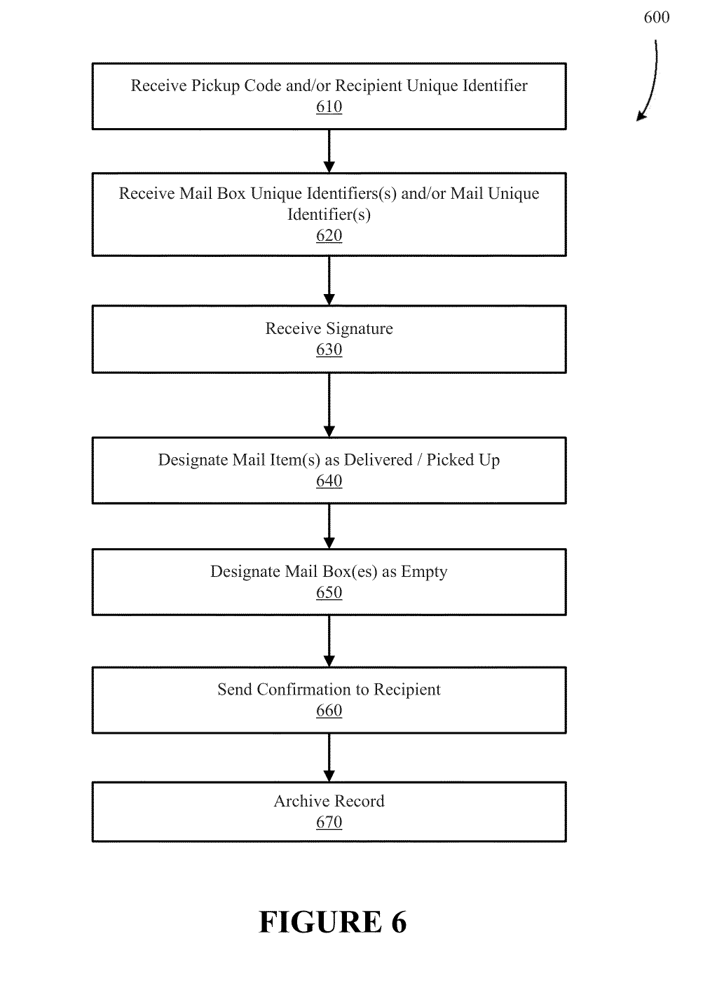

FIG. 6 illustrates aspects of systems and methods for streamlining mail delivery according to an embodiment. The method 600 shown in FIG. 6 may be performed, in part or in whole, by electronic device 200 shown in FIG. 2. In embodiments, method 600 can be performed by one or more of the devices shown in system 300 in FIG. 3.

The method 600 begins in block 610 when a pickup code and/or a unique identifier of a recipient is received. For example, a person wanting to pick up a package may enter a pickup code provided in an email that he or she received notifying them of the package. As another example, a student of a university may enter a student identification number. Numerous other embodiments are disclosed herein and variations are within the scope of this disclosure.

In block 620, one or more mail box unique identifiers and/or mail unique identifiers are received. For example, when a pickup code and/or unique identifier of a recipient is entered into a device such as a tablet computer, one or more data stores may be queried to determine one or more mailboxes that have mail currently stored for the intended recipient. In various embodiments, these mailbox(es) can be displayed on a display of an electronic device so that the mail stored in these mailboxes can be retrieved. In various embodiments, the mailbox unique identifiers and mail unique identifiers are scanned or otherwise entered into a device such as the tablet computer. For example, as an employee picks up the mail from the mailbox(es) the employee can scan or otherwise enter the mailbox unique identifier of each mailbox that mail is retrieved. As another example, as an employee picks up mail from the mailbox(es) the employee may scan or otherwise enter a tracking number, such as a UPS tracking number or a FedEx tracking number, on the package if a tracking number is available. Numerous other embodiments are disclosed herein and variations are within the scope of this disclosure.

In block 630, a signature of the intended recipient is received. For example, the intended recipient may sign a signature box displayed on the display of a tablet computer. In embodiments, the recipient's signature is associated with one or more pieces of mail that the recipient picked up. In some embodiments, the recipient's signature is stored in a database and can be retrieved to prove that a piece of mail has been picked up. Numerous other embodiments are disclosed herein and variations are within the scope of this disclosure.

In block 640, the pieces of mail picked up by the recipient are marked as delivered. For example, a database can be updated such that a delivery date, time, signature, etc. for one or more pieces of mail are shown as being delivered. Numerous other embodiments are disclosed herein and variations are within the scope of this disclosure.

In block 650, the mailbox(es) from which mail was picked up are marked as delivered. For example, if an intended recipient picks up mail from three mailboxes, then one or more databases can be updated to reflect that these three mailboxes are now empty. In various embodiments, an empty mailbox indicates mail for another intended recipient can be put in the mailbox and associated with that intended recipient. Numerous other embodiments are disclosed herein and variations are within the scope of this disclosure.

In block 660, a delivery confirmation is sent to the recipient. For example, an email can be sent to the recipient specifying that the mail has been picked up. Numerous other embodiments are disclosed herein and variations are within the scope of this disclosure.

In block 670, one or more records associated with the picked up mail and/or the intended recipient are archived. For example, information regarding the delivery date, time, signature, tracking information, etc. stored in a database may be copied, moved, or otherwise transferred to a historical database. As described herein, various reports can be generated based at least in part on historical information for mail, intended recipients, and/or mailboxes. Numerous other embodiments are disclosed herein and variations are within the scope of this disclosure.

### Illustrative Method for Streamlining Mail Delivery

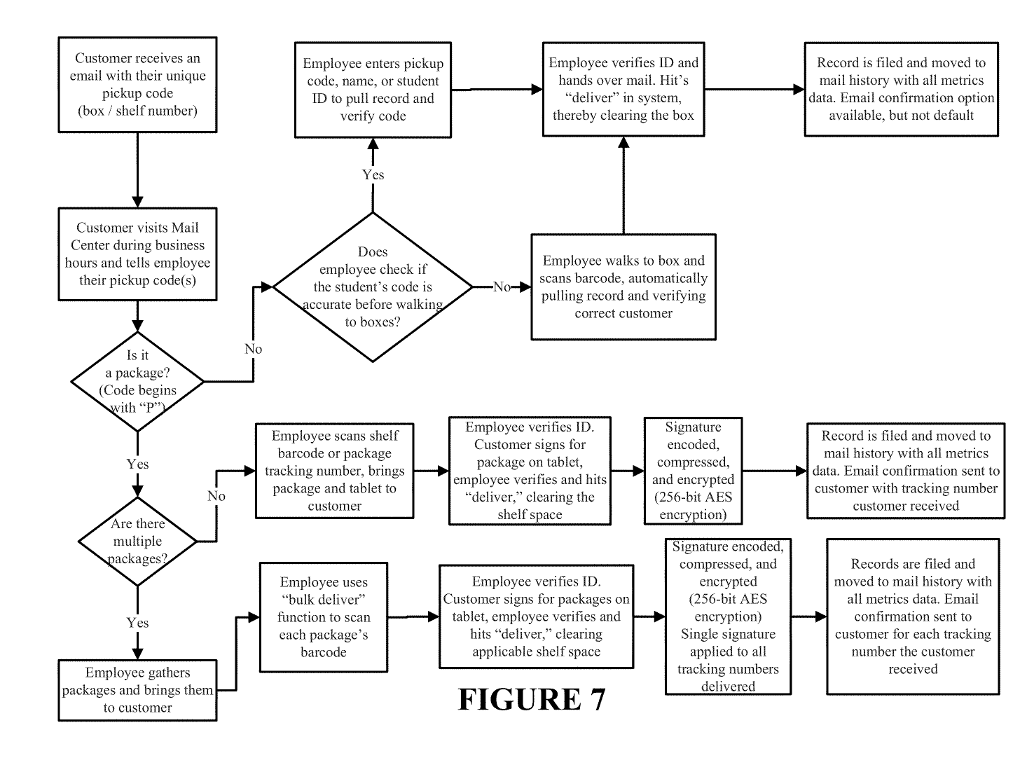

FIG. 7 illustrates aspects of systems and methods for streamlining mail delivery according to an embodiment. The described in the flow chart shown in FIG. 7 may be performed, in part or in whole, by electronic device 200 shown in FIG. 2. In embodiments, steps described in the flow chart shown in FIG. 7 can be performed by one or more of the devices shown in system 300 in FIG. 3. As shown in FIG. 7, the flow chart begins when a customer receives a notification that he or she has received mail. For example, the customer may receive an email stating that he or she has a package waiting. The notification may provide a unique pickup code and/or information, such as a mailbox number and/or shelf number) usable to identify a mailbox where the package is being held. In the flow chart shown in FIG. 7, the customer visits a Mail Center where the package is being hand and provides an employee at the Mail Center with the pickup code contained in the notification.

In the embodiment shown in FIG. 7, a distinction is made between mail that has tracking information (e.g., a UPS package, a FedEx package, etc.) and mail that that does not have tracking information (e.g., a standard USPS letter, etc.). In other embodiments, no distinction is made between mail with and without tracking information. In the embodiment shown in FIG. 7, the pickup code can be used to identify whether the mail that needs to be picked up is a package or a letter. For example, the code may being with a “P” if the mail is package.

As shown in FIG. 7, if a pickup code indicates that the mail is not a package, then the employee can enter the pickup code, the recipient's name, and/or a unique identifier corresponding to the recipient to verify that the pickup code is correct. As another example, if the pickup code corresponds with a particular mailbox, the employee can scan or otherwise enter a unique identifier corresponding with the particular mailbox and retrieve information about the mail and/or the intended recipient. In the embodiment shown in FIG. 7, once the employee has scanned or otherwise entered the unique identifier of the mailbox or searched for the mail by enter a pickup code, name, recipient identification, etc. the employee can select a “Deliver” displayed on the tablet. Moreover, in FIG. 7, when the “Deliver” button is selected, the system is updated to reflect that the mailbox is now empty. In some embodiments, after a particular piece of mail has been delivered, a record corresponding to the mail may be moved to a historical table or database. As discussed below, various reports can be generated and displayed based on the historical data. In some embodiments, an email configuration is sent to the recipient when a piece of mail is picked up.

As shown in FIG. 7, if a pickup code indicates that the mail is a package, then a determination is made whether multiple packages are waiting for the intended recipient. In FIG. 7, if there is only one package, then the employee may use a device, such as a barcode scanner, to scan a barcode corresponding to the mailbox and/or a barcode corresponding to the package. In this embodiment, when a mailbox's barcode and/or a package's barcode is scanned, information about the package is displayed to the employee. The employee may then verify the recipient's identification and have the recipient sign for the package on a device, such as a tablet computer. In some embodiments, the computer displays a “Deliver” button that, when selected, updates a database to indicate that the mailbox is now available or otherwise empty. In some embodiments, a recipient's signature is encoded, compressed, and/or encrypted and stored in a database.

As shown in FIG. 7, if the system indicates that there are multiple package for the intended recipient, then the employee can retrieve all of the packages from their respective mailboxes. In some embodiments, a “Bulk Deliver” feature is available. In this embodiment, the employee can scan a barcode associated with each package. The intended recipient may be able to sign once for all of the packages. In one embodiment, an employee can select a single “Deliver” button for all of the packages. In this embodiment, when the “Deliver” button is selected, one or more databases are updated to indicate that the mailboxes associated with the packages that are being picked up are now available or otherwise empty. Numerous other embodiments are disclosed herein and variations are within the scope of this disclosure.

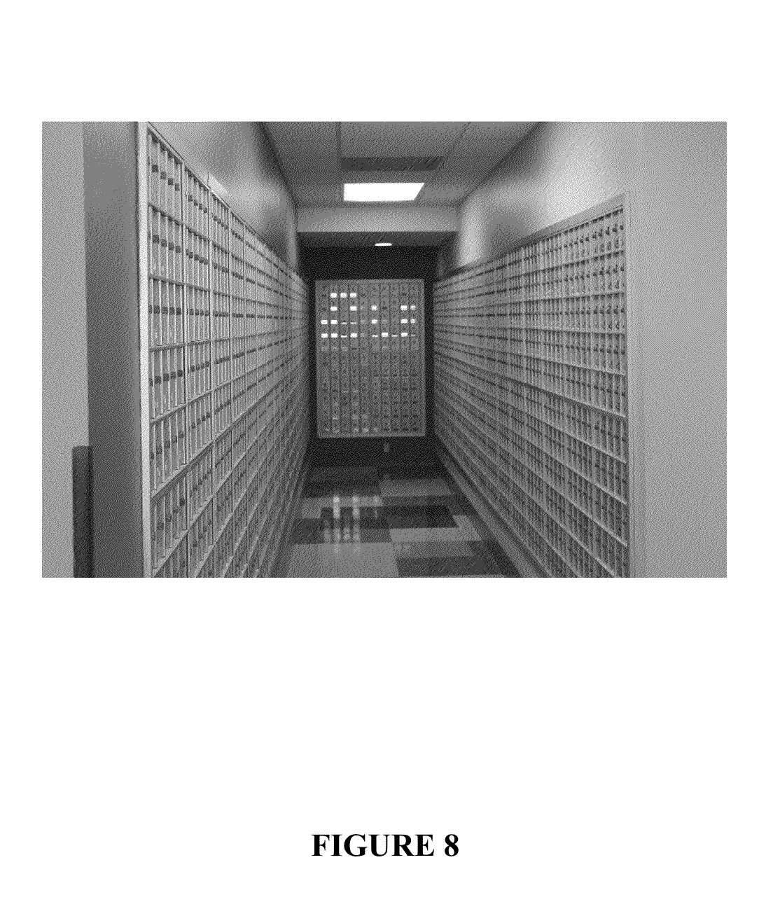

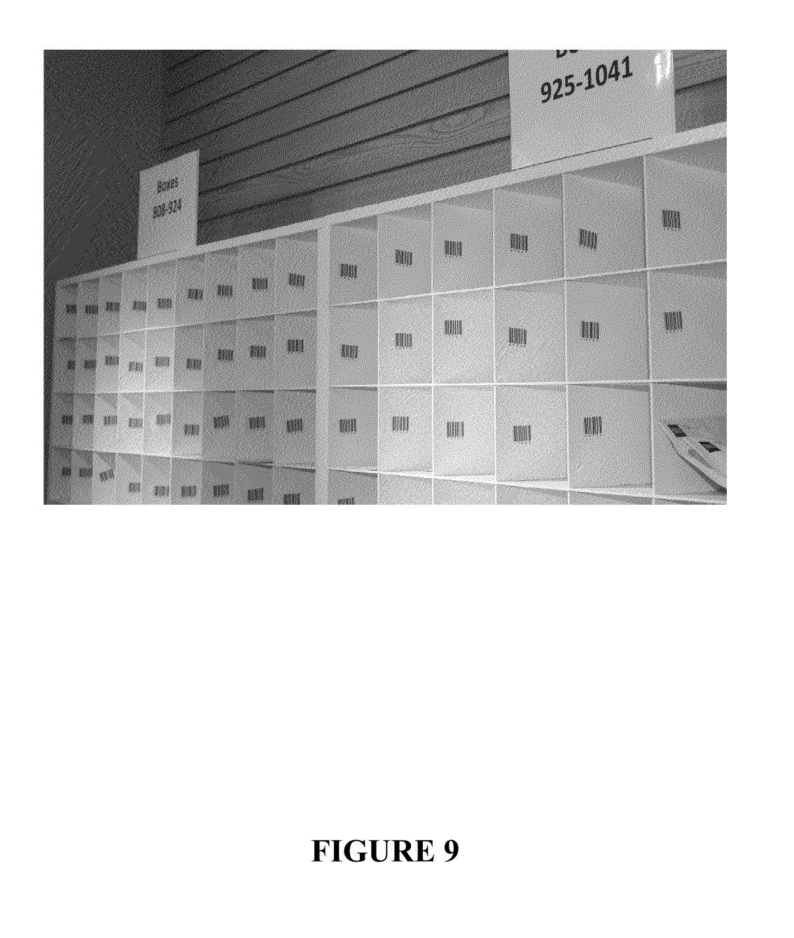

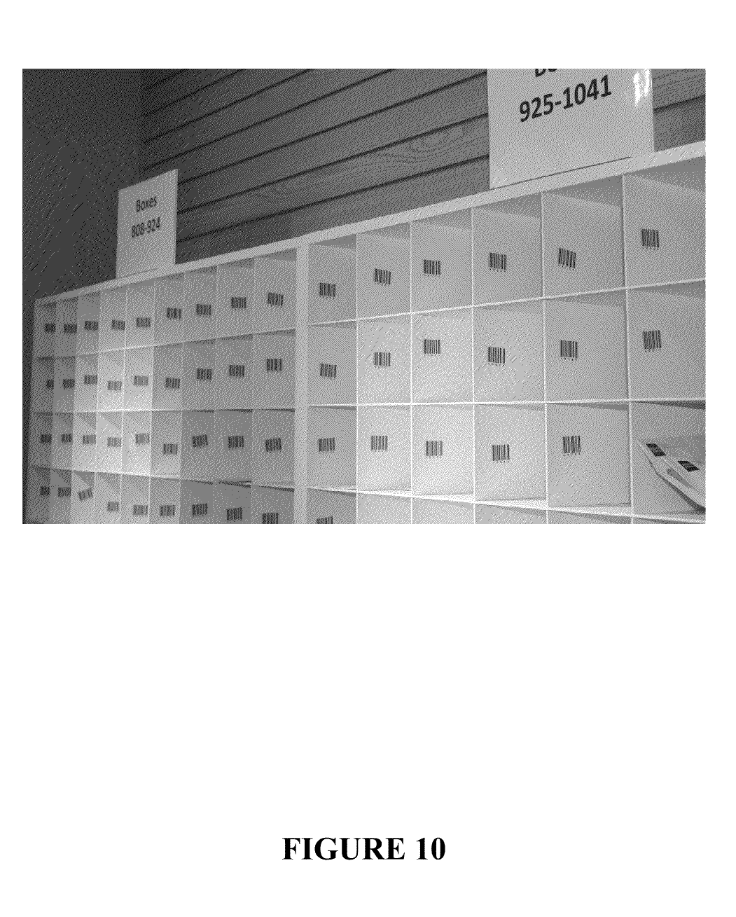

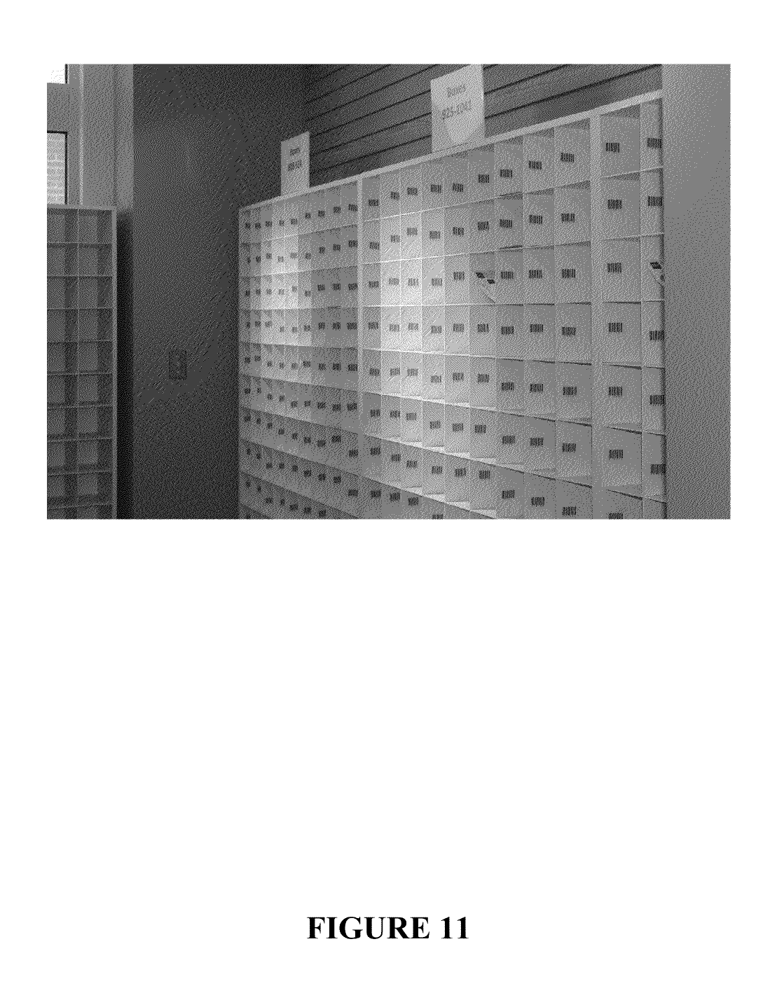

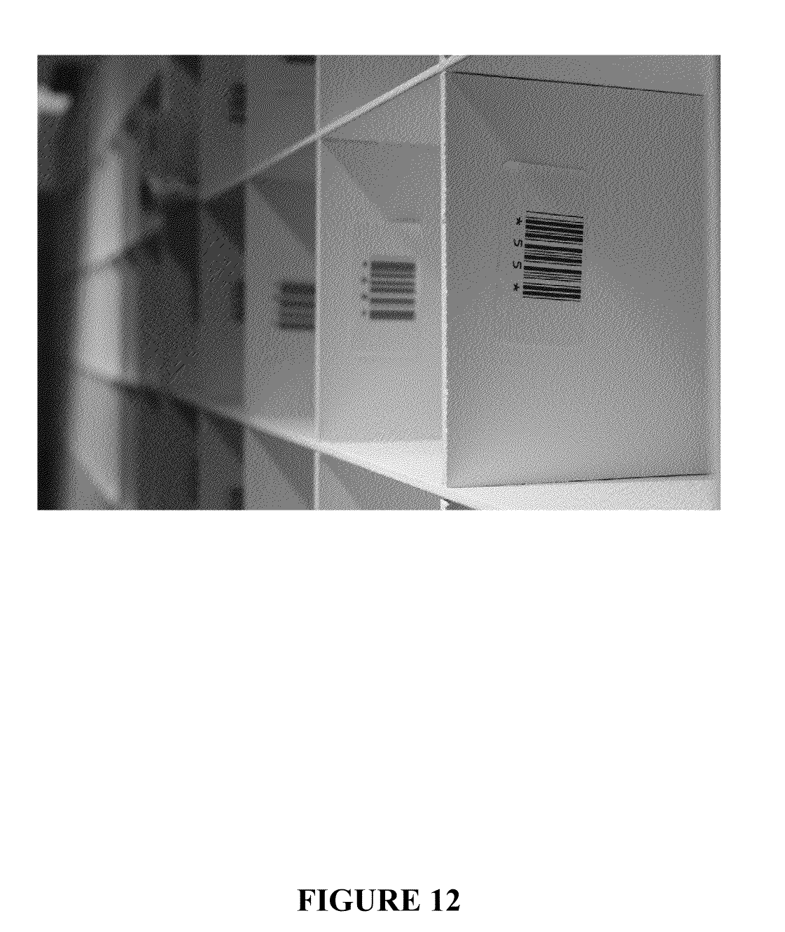

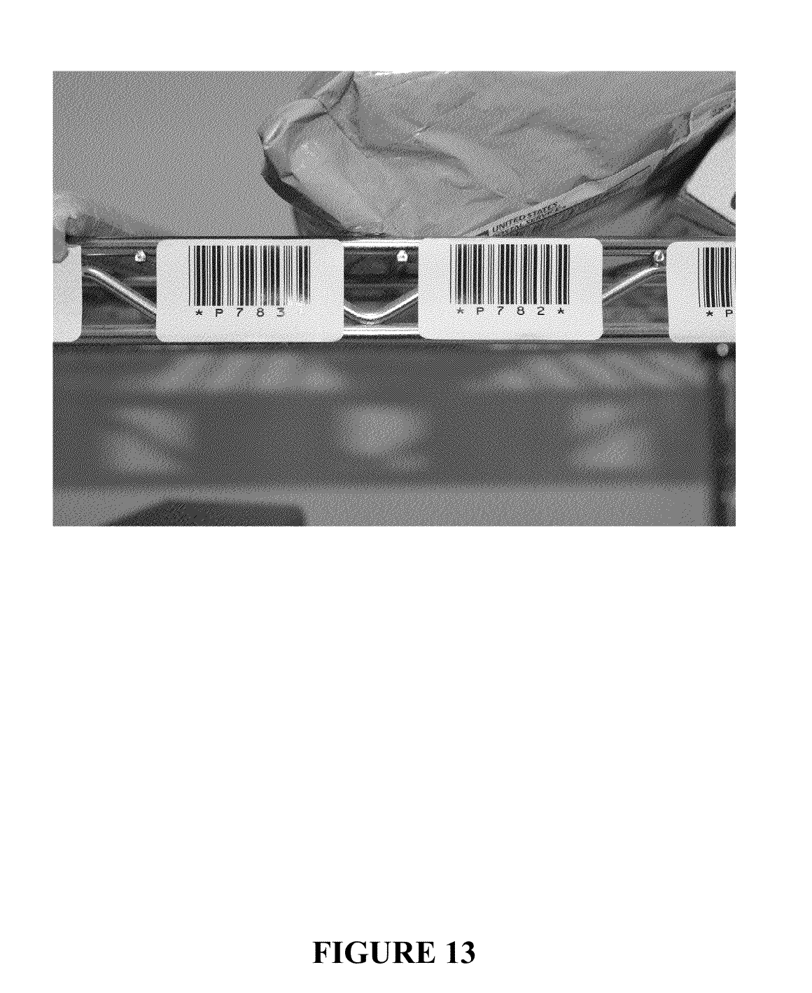

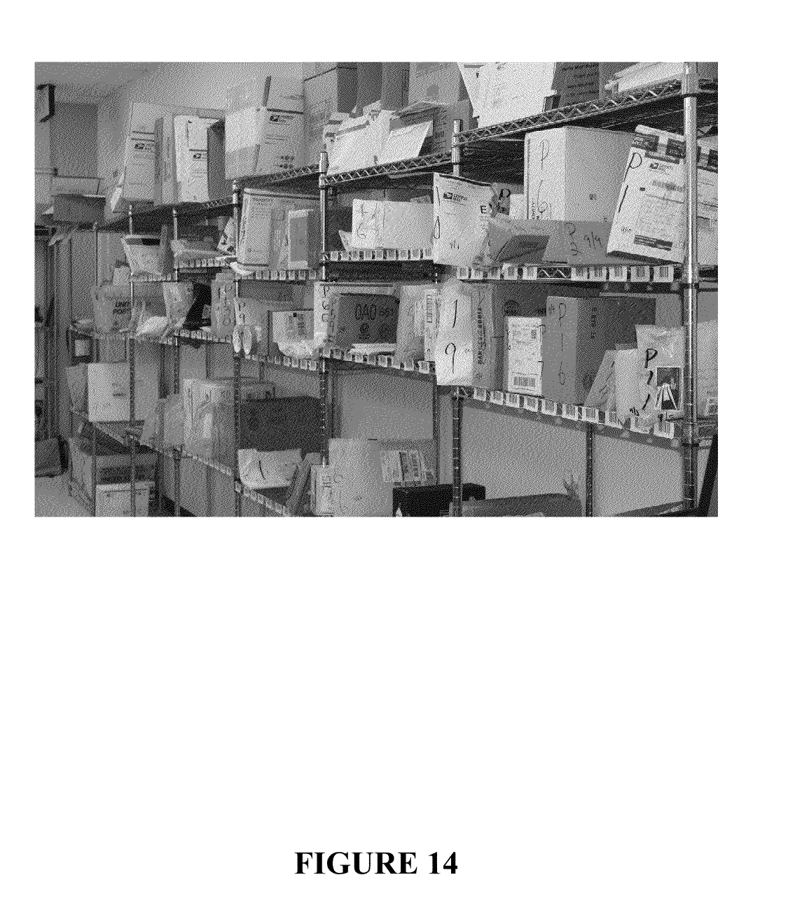

FIGS. 8-14 illustrates aspects of systems and methods for streamlining mail delivery according to an embodiment. FIGS. 8-14 provide various views of dynamic mailboxes. In embodiments, the mailboxes shown in FIG. 8-14 are not assigned to a particular member of an organization. Instead, in some embodiments, each mailbox is associated with a unique identifier. For example, in FIGS. 8-14, each mailbox (e.g., storage space) corresponds with a different barcode. When a determination is made to place a piece of mail in a particular mailbox, the unique identifier can be scanned or otherwise entered and one or more databases can updated to reflect that the mailbox is currently occupied. In some embodiments, when a mailbox is being occupied, one or more databases associate the mailbox with one or more identifiers corresponding to the mail that is being held in the mailbox. In some embodiments, when a mailbox is being occupied, one or more databases associated the mailbox and/or the mail that is being held in the mailbox with information to identify an intended recipient of the mail. Thus, instead of each member of an organization being required to have a predetermined mailbox, in embodiments mailboxes can be dynamically determined thereby reducing the amount of space required. Similarly, in embodiments, when a piece of mail is picked up, an identifier corresponding with the piece of mail and/or an identifier corresponding with a mailbox holding the piece of mail can be scanned or otherwise entered. In this embodiment, the mailbox may be marked as available or empty and/or the piece of mail may be marked as delivered. Numerous other embodiments are disclosed herein and variations are within the scope of this disclosure.

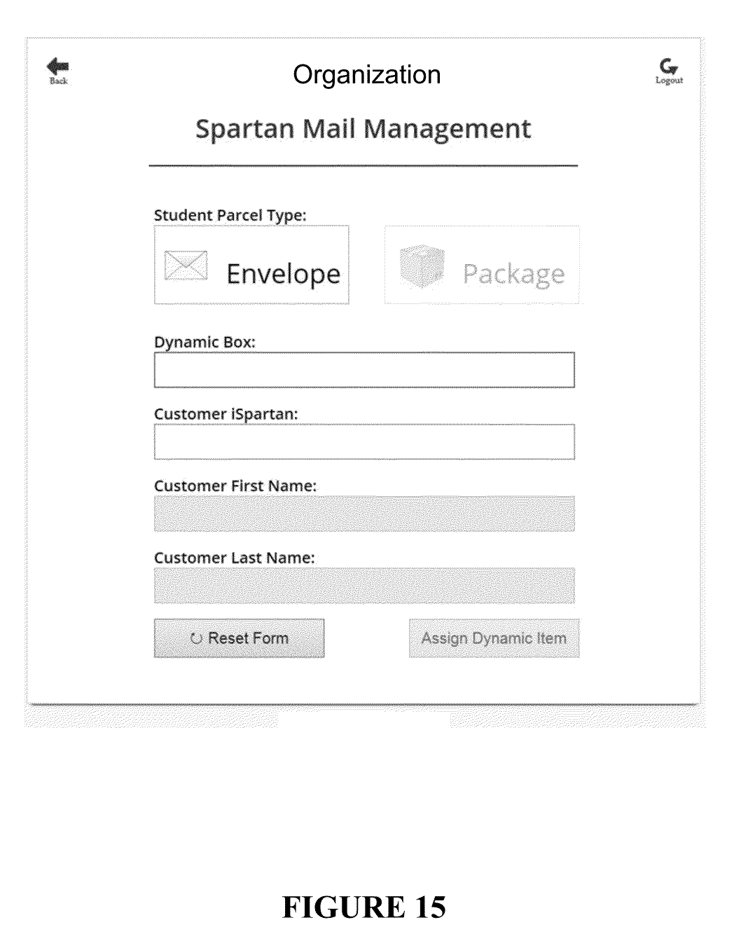

FIG. 15 illustrates aspects of systems and methods for streamlining mail delivery according to an embodiment. In FIG. 15, a form for dynamically assigning items is provided. For example, in FIG. 15, a user can selected whether the item is an Envelope or a Package, scan or otherwise enter a mailbox, and/or scan or otherwise enter an intended recipient. As another example, in one embodiment, a user may scan a barcode or otherwise enter tracking information corresponding to a package that needs to be delivered. In this embodiment, the user may scan a barcode or otherwise enter a mailbox that the package will be placed into. Moreover, in this embodiment, the user may enter an identification corresponding to the intended recipient of the package. For example, the user may enter a unique identifier corresponding to the intended recipient such as a username, an email address, etc. In some embodiments, an identifier corresponding to the intended recipient can be searched based on information such as the intended recipient's first name, last name, email address, etc. In one embodiment, an address for the intended recipient specified on the package can provide the unique identifier for the intended recipient. For example, as shown in FIG. 1, the address of the intended recipient has a unique identifier as part of the address. As another example, in one embodiment, each member of an organization has a unique identifier that is part of his or her address. Thus, in this embodiment, when a package is addressed to a particular member of the organization, the package may have an address that can be used to identify the intended recipient based on the unique identifier in the address. In the embodiment shown in FIG. 15, when the “Assign Dynamic Item” is selected, one or more databases can be updated to associate the mail (e.g., package or envelope) with the mailbox, and/or the intended recipient. In some embodiments, an email is also sent to the intended recipient providing information regarding the mail, the mailbox that the mail is stored in, and/or a delivery code that can be used to pick up the mail. Numerous other embodiments are disclosed herein and variations are within the scope of this disclosure.

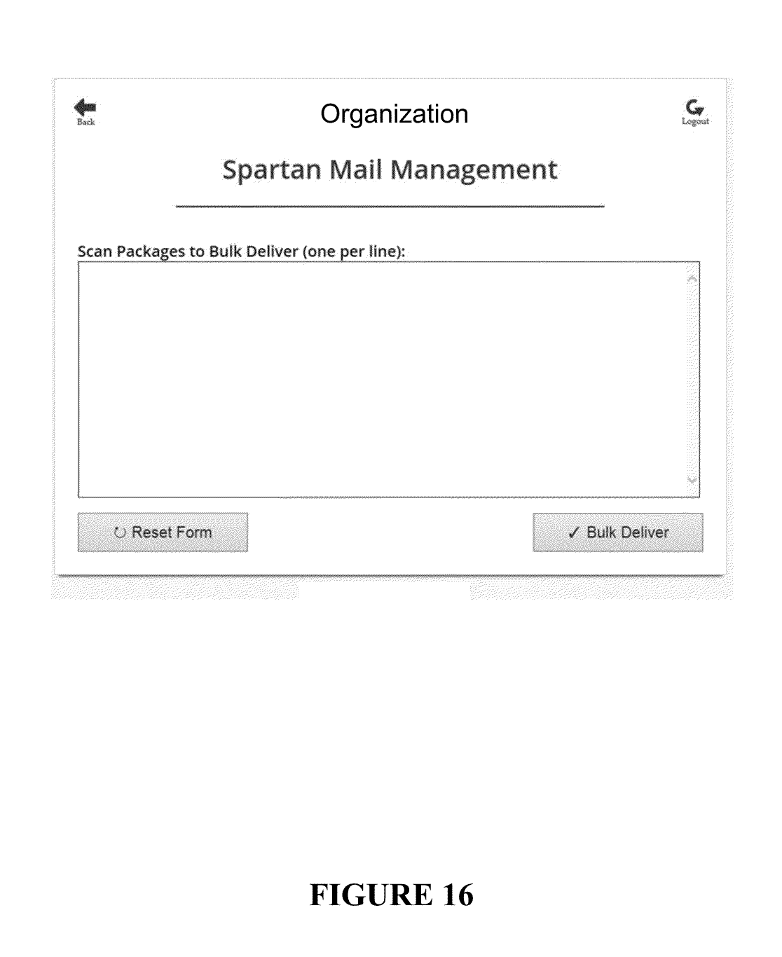

FIG. 16 illustrates aspects of systems and methods for streamlining mail delivery according to an embodiment. As shown in FIG. 16, in some embodiments, multiple packages can be simultaneously or substantially simultaneously marked as delivered. For example, in an embodiment, a user can scan or otherwise enter tracking information corresponding to two or more pieces of mail. In the embodiment shown in FIG. 16, when a user selects the “Bulk Deliver” button, each piece of mail corresponding to the tracking information scanned or otherwise entered into the bulk delivery textbox is marked as delivered. In some embodiments, mailboxes corresponding to the scanned or otherwise entered tracking information are marked as available or empty when the “Bulk Deliver” option is selected. Numerous other embodiments are disclosed herein and variations are within the scope of this disclosure.

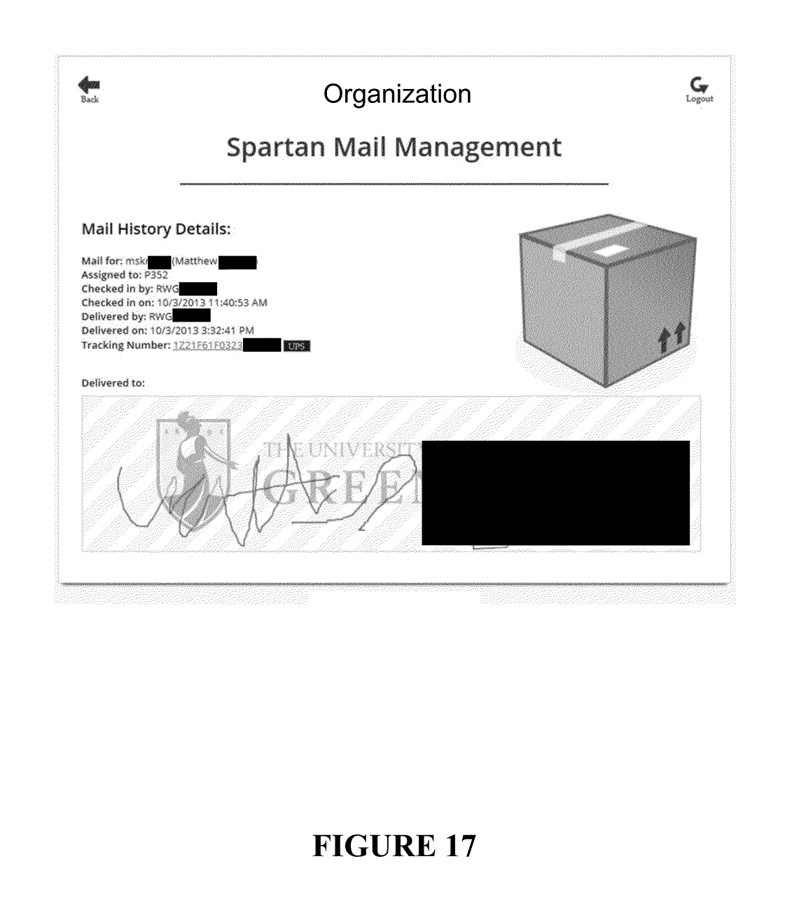

FIG. 17 illustrates aspects of systems and methods for streamlining mail delivery according to an embodiment. As shown in FIG. 17, a report providing historical details for one or more pieces of mail can be provided. For example, a report can be generated for a particular piece of mail that provides a name and/or identifier of the intended recipient of the piece of mail, a mailbox to which the mail is or was previously assigned, a name and/or identifier of a person who checked in the mail, a date and/or time that the mail was checked in, a name and/or identifier of a person who delivered the mail, a date and/or time that the mail was delivered, a tracking number, and/or a signature of the person that picked up the mail. Numerous other embodiments are disclosed herein and variations are within the scope of this disclosure.

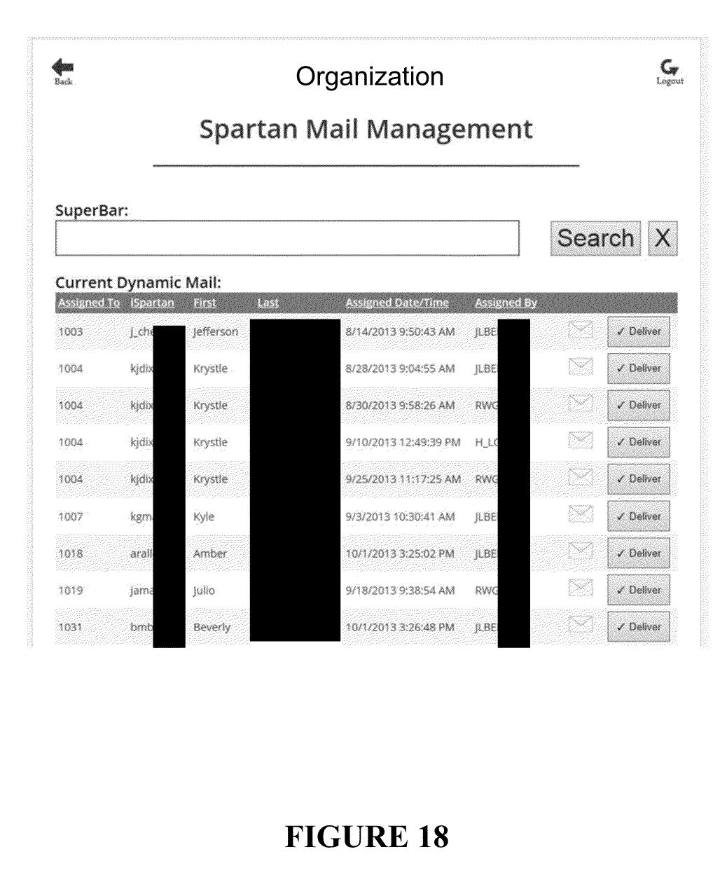

FIG. 18 illustrates aspects of systems and methods for streamlining mail delivery according to an embodiment. As shown in FIG. 18, a report providing information regarding currently assigned mail can be provided. For example, a report of all assigned mail that has not yet been picked up or delivered can be provided. As another example, a report mail assigned on a particular day or range of days that has not yet been picked up or delivered can be provided. In some embodiments, a search can be performed for a particular box, name, unique identifier, and/or assigned date and/or time. In this embodiment, a report can be generated and displayed that satisfies the criteria provided by the search. In some embodiments, one or more undelivered packages can be marked as delivered by selecting a “Deliver” button corresponding the piece of mail. When the “Deliver” button is selected for a particular piece of mail, a mailbox corresponding to that piece of mail may be marked as empty or available and/or the piece of mail may be marked as delivered. Numerous other embodiments are disclosed herein and variations are within the scope of this disclosure.

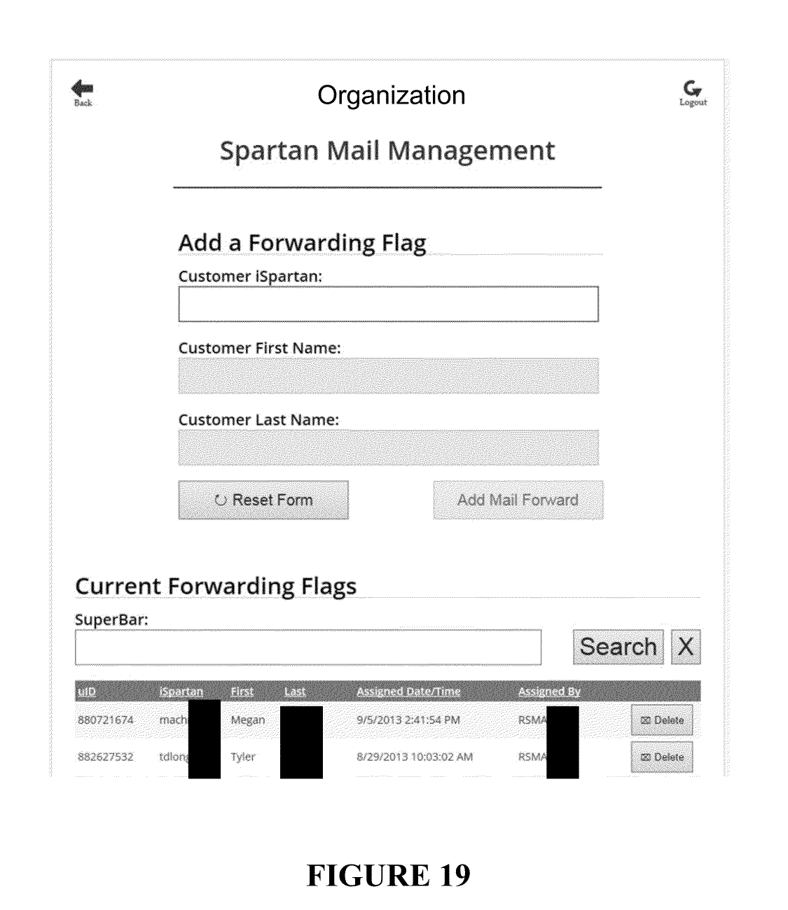

FIG. 19 illustrates aspects of systems and methods for streamlining mail delivery according to an embodiment. In some embodiments, a forwarding option is provided. For example, a member of an organization may submit a request to have his or her mail delivered to a different location. In this embodiment, when a piece of mail intended for the member of the organization is received, the piece of mail is forwarded to the different location. As shown in FIG. 19, a report of forwarding requests can be generated. Such a report can include information such as unique identifiers corresponding to members of the organization, names, dates and/or times that the forwarding request was entered, dates and/or times that the forward request terminates, information to identify who entered and/or approved the forwarding request, etc. Numerous other embodiments are disclosed herein and variations are within the scope of this disclosure.

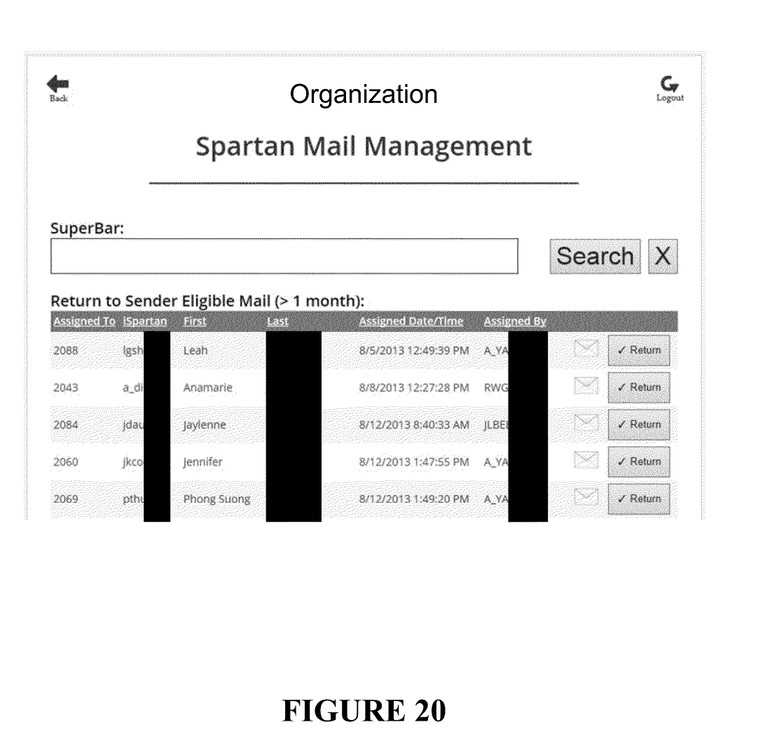

FIG. 20 illustrates aspects of systems and methods for streamlining mail delivery according to an embodiment. As shown in FIG. 20, embodiments allow mail to be returned to its sender if an assigned package has not been picked up/delivered within a specified time frame. For example, in FIG. 20, a report of mail that has been assigned, but not delivered, for more than one month is displayed. A particular piece of mail can be returned to its sender by selecting the “Return” button displayed on the report. In embodiments, when the “Return” button is selected for one or more pieces of mail, then mailbox(es) associated with the one or more pieces of mail are marked as empty/available for use. In some embodiments, an email is sent to the intended recipient stating that a piece of mail has been returned because it has not been picked up. Numerous other embodiments are disclosed herein and variations are within the scope of this disclosure.

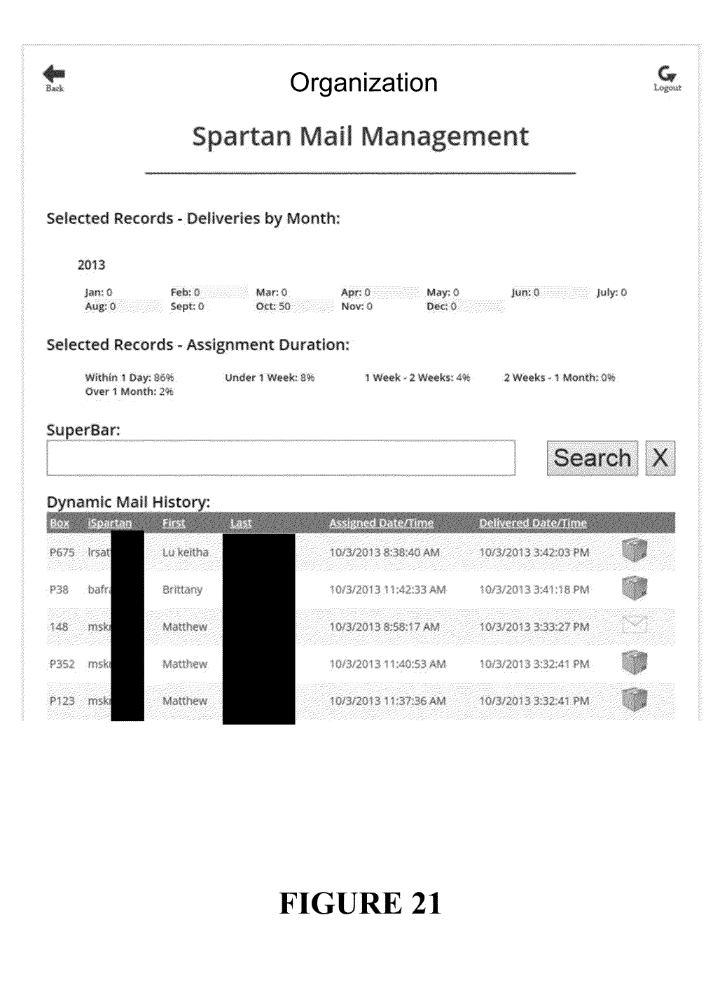

FIG. 21 illustrates aspects of systems and methods for streamlining mail delivery according to an embodiment. As shown in FIG. 21, in some embodiments, reports providing statistics regarding deliveries, assignment durations, unique mailbox identifiers, unique delivery recipients, names, assignment dates and/or times, and/or delivery dates and/or times may be generated. In FIG. 21, the number of deliveries for each month of a year are displayed; however generating reports with the number of deliveries over a given day, week, month, year, and/or range of dates can be provided in various embodiments. In some embodiments, statistics regarding the amount of time that an assigned package was held in a box can be determined by, for example, comparing an assigned time with a delivery time of a package. In some embodiments, searches can be performed to determine information associated with a particular box, recipient, assignment timeframe, and/or delivery timeframe. Numerous other embodiments are disclosed herein and variations are within the scope of this disclosure.

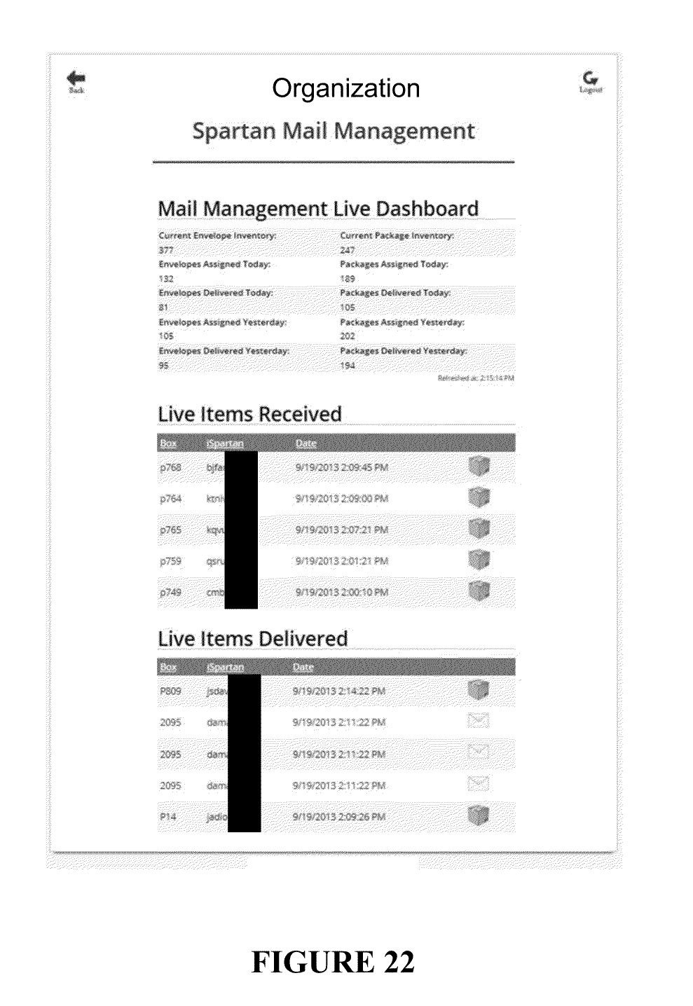

FIG. 22 illustrates aspects of systems and methods for streamlining mail delivery according to an embodiment. As shown in FIG. 22, in some embodiments, various reports, including but not limited to, inventory, assignments, and/or deliveries can be provided. For example, a report for the current inventory of packages or letters, or both, may be provided. As another example, reports for the number of items that have been assigned and/or delivered over a predefined period of time (e.g., today, yesterday, this month, last month, two dates or a range of dates, etc.) can be provided. In one embodiment, a live reporting of the latest items received and/or delivered may be provided. In some embodiments, live updates regarding items can be provided dynamically, without refreshing a reporting page. For example, if a report displayed in a web browser, then a portion of the report corresponding to live updates may be updated without updating the entire report. Numerous other embodiments are disclosed herein and variations are within the scope of this disclosure.

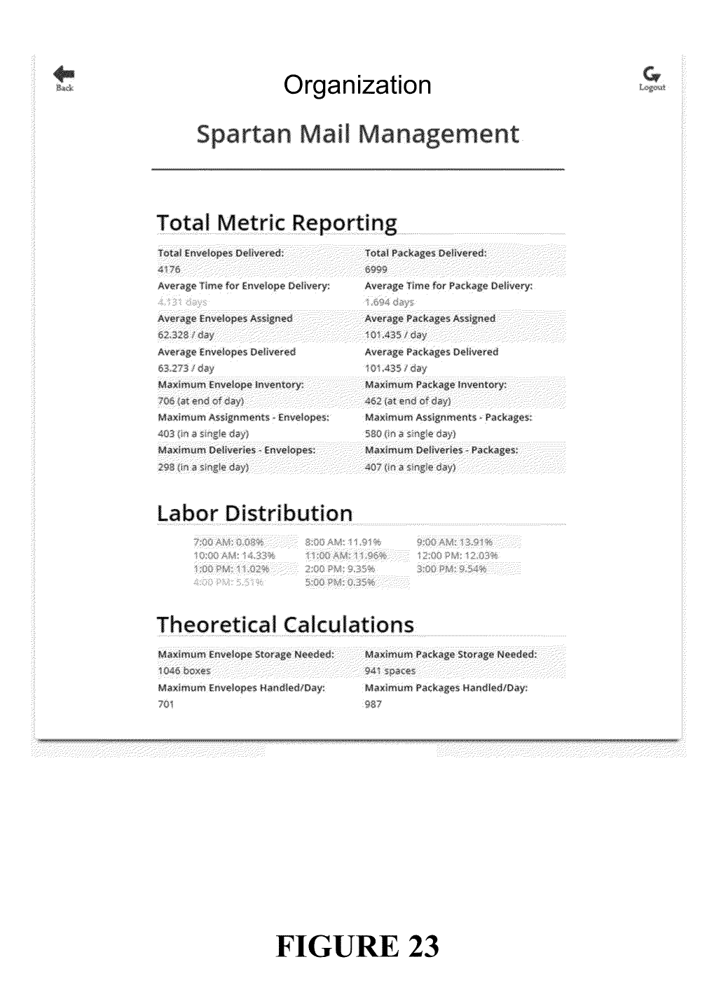

FIG. 23 illustrates aspects of systems and methods for streamlining mail delivery according to an embodiment. As shown in FIG. 23, in some embodiments, various reports, including but not limited to, metric reporting, labor distribution, and/or various capacity requirements can be provided. For example, in various embodiments, one or more reports providing statistics regarding total deliveries, average delivery time, average number of assignments, average number of deliveries, maximum inventory, maximum assignments, and/or maximum deliveries can be provided. In some embodiments, a user can request one or more statistics for over a predetermined period of time (e.g., a day, a month, a year, a range of days, etc.). Moreover, in some embodiments, one or more reports can be generated that describe the amount of labor and/or time that the system is being used. For example, the report shown in FIG. 23 describes the distribution of labor currently being used at various times of the day. In some embodiments, statistics regarding a maximum, minimum, and/or average amount of storage may be provided in one or more reports. As another example, a maximum, minimum, and/or average capacity to handle mail can be provided by one or more reports. In some embodiments, a prediction regarding the amount of space that will be required for a specified number of members can be determined and reported based at least in part on historical information of previous deliveries, hold times, storage requirements, mail (e.g., packages and/or letters) handled per day, etc. Numerous other embodiments are disclosed herein and variations are within the scope of this disclosure.

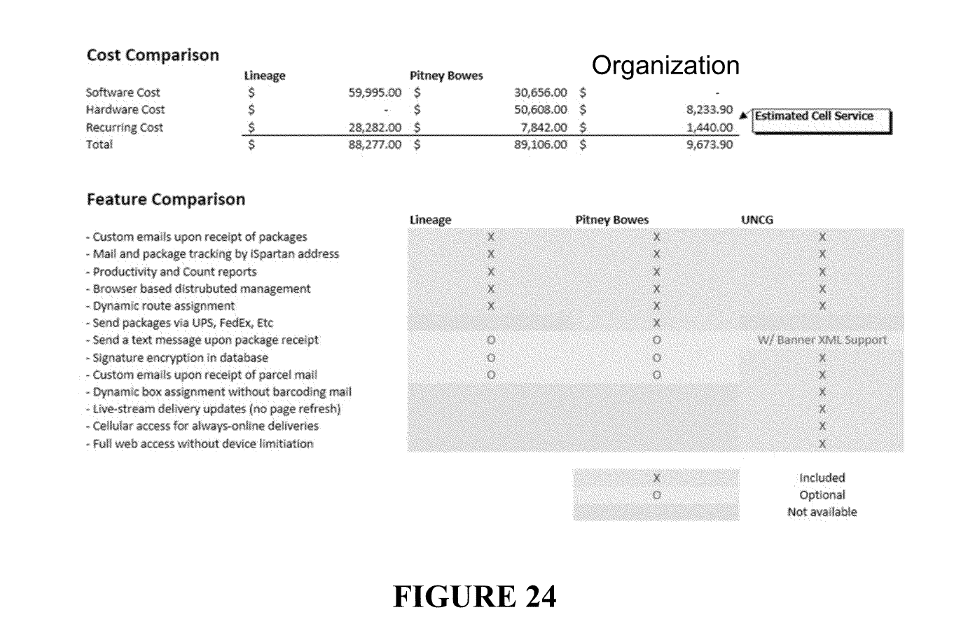

FIG. 24 illustrates aspects of systems and methods for streamlining mail delivery according to an embodiment. As shown in FIG. 24, the software cost, hardware cost, and/or recurring costs of a system for streamlining mail delivery may be lower than at least some other methods of mail delivery. In embodiments, a system and/or method for streamlining mail delivery can have one or more of the following features and/or other features: custom emails upon receipt of packages, mail and package tracking by unique identifier, mail and package tracking by email address, productivity reporting, count reporting, browser based distributed management, dynamic route assignment, text message notification, signature encryption in database, custom emails, dynamic box assignment for mail with tracking information, dynamic box assignment for mail without tracking information, live-stream delivery updates, cellular access for always-online deliveries, and/or fully web accessible. Numerous other embodiments are disclosed herein and variations are within the scope of this disclosure.

It will be recognized that any number of data stores and/or schemas may be used to streamline mail delivery. One example of such a database schema is provided below in TABLE 1, which describes a database schema of a mail system at a university according to an embodiment. Numerous other embodiments are disclosed herein and variations are within the scope of this disclosure.

TABLE 1
Example Database Schema According to an Embodiment

| Database Table | Database Column | Description |
|---|---|---|
| mailAdmin | | A table of authorized administrators |
| | ID | Unique row ID |
| | Username | Username of the Administrator |
| | Date | Date entered into table |
| mailUsers | | A table of authorized employees |
| | ID | Unique row ID |
| | Username | Username of the employee |
| | Date | Date entered into table |
| mailCurrent | | Table of the current mail waiting to be delivered - full- |
| | | text catalog for searching |
| | ID | Unique row ID |
| | uID | University ID number of the mail recipient |
| | Box | Box number or shelf assigned |
| | iSpartan | University username of the mail recipient |
| | First | Recipient's first name |
| | Last | Recipient's last name |
| | AssignedBy | Username of the employee who assigned the mail |
| | trackingNumber | Tracking number (if applicable) |
| | isPackage | True/False - Is this a package? |
| | Date | Date mail was checked into system |
| mailHistory | | Table of all mail history and signatures - full-text |
| | | catalog for searching |
| | ID | Unique row ID |
| | uID | University ID number of the mail recipient |
| | Box | Box number or shelf assigned |
| | iSpartan | University username of the mail recipient |
| | First | Recipient's first name |
| | Last | Recipient's last name |
| | AssignedBy | Username of the employee who assigned the mail |
| | trackingNumber | Tracking number (if applicable) |
| | Sig | Encrypted signature (if package) |
| | isPackage | True/False - Is this a package? |
| | RTS | True/False - Was this returned to sender? |
| | DeliveredBy | Username of the employee who delivered the mail |
| | DateAssigned | Date mail was checked into system |
| | DateDelivered | Date mail was delivered to customer |
| mailForwards | | Table of Usernames who want their mail forwarded - |
| | | full-text catalog for searching |
| | ID | Unique row ID |
| | uID | University ID number of the customer who wants mail |
| | | forwarded |
| | iSpartan | University username of the customer who wants mail |
| | | forward |
| | First | Recipient's first name |
| | Last | Recipient's last name |
| | AssignedBy | Username of the employee who assigned the mail |
| | Date | Date forwarding request was recorded |

### General

While the methods and systems herein are described in terms of software executing on various machines, the methods and systems may also be implemented as specifically-configured hardware, such as field-programmable gate array (FPGA) specifically configured to execute the various methods. For example, embodiments can be implemented in digital electronic circuitry, or in computer hardware, firmware, software, or in a combination thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for streamlining mail delivery. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

Reference herein to “one embodiment” or “an embodiment” means that a particular feature, structure, operation, or other characteristic described in connection with the embodiment may be included in at least one implementation of the invention. The invention is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

The order of the blocks and/or steps presented in the examples above for embodiments of the methods disclosed herein can be varied—for example, blocks can be re-ordered, combined, and/or broken into sub-blocks. Certain blocks or processes can be performed in parallel. Thus, while the steps of methods disclosed herein have been shown and described in a particular order, other embodiments may comprise the same, additional, or fewer steps. Some embodiments may perform the steps in a different order or in parallel.

The use of “adapted to” or “configured to” herein is meant as open and inclusive language that does not foreclose devices, systems, or methods adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A system comprising:
a plurality of storage locations, each storage location in the plurality of storage locations corresponding with a respective unique storage location identifier, wherein a storage location in the plurality of storage locations is configured to be dynamically determined for a physical mail item comprising an intended recipient; and
at least one electronic device, wherein the at least one electronic device is configured to:
associate the storage location with the intended recipient; and
send an electronic notification to the intended recipient, the electronic notification comprising a pickup code corresponding the storage location.

2. The system of claim 1, wherein the pickup code is the respective unique storage location identifier corresponding with the dynamically determined storage location.

3. The system of claim 1, wherein the at least one electronic device temporarily associates the storage location with the intended recipient until the physical mail item is removed from the storage location.

4. The system of claim 1, wherein a respective storage location in the plurality of storage locations is not associated with more than one intended recipient at a given time.

5. The system of claim 1, wherein the storage location in the plurality of storage locations is dynamically determined for the physical mail item based at least in part on a determination that a respective storage location in the plurality of storage locations is associated with the intended recipient and wherein the respective storage location is the dynamically determined storage location.

6. The system of claim 1, wherein the storage location in the plurality of storage locations is dynamically determined for the physical mail item based at least in part on a determination that the storage location is empty and that the storage location is not associated with any recipient.

7. The system of claim 1, wherein the at least one electronic device is configured to:
determine that an additional storage location in the plurality of storage locations is associated with the intended recipient, the additional storage location comprising an already received physical mail item for the intended recipient;
provide a message to move the already received physical mail item from the additional storage location to the storage location; and
disassociate the additional storage location from the intended recipient.

8. A method comprising:
receiving, by a processor, a recipient identifier, the recipient identifier corresponding to a physical mail item addressed to an intended recipient;
dynamically determining a storage location from a plurality of storage locations for the physical mail item, wherein the storage location is not yet associated with the intended recipient when the storage location is dynamically determined;
associating, by the processor, the storage location and the intended recipient; and
sending, by the processor, an electronic notification to the intended recipient, the electronic notification comprising a storage location identifier associated with the storage location.

9. The method of claim 8, wherein the physical mail item comprises a package or a letter.

10. The method of claim 8, wherein the intended recipient is a member of an organization and the recipient identifier comprises a unique member identifier corresponding to the member of the organization.

11. The method of claim 10, wherein the physical mail item comprises an address for the member of the organization, the address comprising the unique member identifier.

12. The method of claim 11, wherein the unique member identifier corresponds to an electronic communication address of the member of the organization.

13. The method of claim 8, wherein dynamically determining the storage location from the plurality of storage locations for the physical mail item comprises receiving, by the processor, a mailbox identifier corresponding to an empty mailbox in the plurality of storage locations.

14. The method of claim 13, wherein associating, by the processor, the storage location and the intended recipient comprises associating, by the processor, the mailbox identifier with the recipient identifier.

15. The method of claim 8, wherein dynamically determining the storage location from the plurality of storage locations for the physical mail item comprises dynamically determining, by the processor, an empty mailbox in the plurality of storage locations.

17. The method of claim 8, wherein each storage location corresponds to a respective unique location identifier and wherein the storage location identifier corresponds to the dynamically determined storage location.

17. The method of claim 8, wherein the electronic notification comprises at least one of an email or a text message.

18. The method of claim 8, further comprising:
receiving, by the processor, the storage location identifier;
identifying, by the processor, the storage location based at least in part on the storage location identifier;
receiving, by the processor, a confirmation that the physical mail item has been retrieved from the storage location; and
after receiving the confirmation, disassociating, by the processor, the storage location from the intended recipient.

19. The method of claim 18, wherein the confirmation comprises a signature of the intended recipient.

20. The method of claim 18, further comprising:
receiving, by the processor, an additional recipient identifier different than the recipient identifier, the additional recipient identifier corresponding to an additional physical mail item addressed to an additional intended recipient, wherein the additional physical mail item comprises an additional package or an additional letter;
determining, by the processor, the storage location for the additional physical mail item based at least in part on the storage location being disassociated from the intended recipient; and
associating, by the processor, the storage location with the additional intended recipient.
